(19) United States
(12) Patent Application Publication
(10) Pub. No.: US 2025/0312960 A1
(43) Pub. Date: Oct. 9, 2025

(54) METHODS AND SYSTEMS OF CONTINUOUS FORMING

(71) Applicant: University of Maine System Board of Trustees, Orono, ME (US)

(72) Inventors: Cody Alexander Sheltra, Brewer, ME (US); Roberto Antonio Lopez-Anido, Orono, ME (US); William Glenn Davids, Orono, ME (US); Zane Dustin, Old Town, ME (US)

(21) Appl. No.: 18/865,249

(22) PCT Filed: Apr. 21, 2023
(86) PCT No.: PCT/US23/19433

§ 371 Date: Nov. 12, 2024

Related U.S. Application Data
(60) Provisional application No. 63/346,493, filed on May 27, 2022.

(51) Int. Cl. B29C 48/06; B29K 101/12; B29K 105/10

(52) U.S. Cl. CPC B29C 48/06; B29K 2101/12; B29K 2105/106

(57) ABSTRACT

Presented herein are methods and systems of continuous forming for manufacturing of thermoplastic products (e.g., continuous fiber-reinforced thermoplastic products) from feed materials comprising thermoplastic components. Disclosed methods and systems include heating feed materials to above the glass transition temperature of thermoplastic components, forming consolidated materials from heated feed materials, and cooling consolidated materials to below the glass transition temperature. Further, methods and systems of the present disclosure may include optional steps and/or units which further enable manufacturing thermoplastic products having any of a variety of forms, structures, and/or profiles.

### CROSS-REFERENCE TO RELATED APPLICATIONS

This application claims priority to U.S. Provisional Application 63/346,493 filed on May 27, 2022, the entirety of which is incorporated herein by reference.

### GOVERNMENT SUPPORT

This invention was made with government support under W52P1J2093014, W912HZ219F003, and W912HZ229C005 by the Department of the Army. The government has certain rights in the invention.

### BACKGROUND

Traditional pultrusion methods and systems which manufacture fiber-reinforced polymer products utilize thermoset feed materials to produce exemplary products. Such methods and systems require use of highly undesirable materials, such as volatile organic compounds (VOCs) and pose health and/or environmental hazards during and/or after manufacturing.

### SUMMARY

The present disclosure provides, among other things, methods and systems of continuous forming for manufacturing thermoplastic products (e.g., fiber-reinforced thermoplastic products) utilizing feed materials comprising thermoplastic materials. As provided herein, use of feed materials comprising thermoplastic materials provides advantages over traditional pultrusion methods and systems which utilize thermoset materials. Such traditional methods and systems rely on pulling fiber components through resin saturation systems, which are then cured in a die to produce final products. Such methods and systems present severe health and/or environmental hazards, inter alia, because of their high emission of VOCs during processing. In many embodiments, disclosed methods and systems of continuous forming utilize feed materials comprising thermoplastic components, wherein such thermoplastic components are commingled with fiber components. Such exemplary embodiments do not require use of resin saturation systems, significantly decreasing VOC emissions and therefore health and/or environmental risks. Additionally, use of feed materials comprising thermoplastic materials in disclosed methods and systems provides for reheating and therefore reforming of thermoplastic products, enabling increased recyclability and providing further environmental advantages over traditional methods and systems.

Further, as provided herein, disclosed methods and systems provide for manufacturing a wider-range of exemplary products (e.g., fiber-reinforced thermoplastic products) than traditional methods and systems. For example, continuous forming methods and systems of the present disclosure provide for manufacturing products having geometries such as flat plates, round bars, pipe sections, sandwich panels, lineal profiles with open and closed sections, etc. Such capabilities are due, at least in part, to use of feed materials comprising thermoplastic components and/or a wider selection of feed material forms that can be utilized, such as tapes, fibers, fabrics, etc. Additionally, some aspects of disclosed methods and systems allow for tailoring products with application-specific characteristics, like ridges or depressions, in a more efficient manner. In a non-limiting example, roll forming allows for manufacturing products having ridged surface profiles. While traditional methods and systems which utilize thermoset materials can manufacture products with surface ridges or depressions, they require post-production machining or technically challenging and costly secondary molding processes.

The present disclosure encompasses the recognition of challenges in continuous forming of feed materials comprising thermoplastic materials and provides ways to overcome those challenges. For example, thermoplastic materials have viscosities about 4× greater than thermoset materials during processing. One of skill in the art will appreciate that such processing characteristics leads to significant disadvantages in pultruding thermoplastic materials, such as low manufacturing rates (e.g., pulling rates on the order of mm/min) and/or need for complex methods and systems (e.g., methods and systems comprising vacuuming), such as those reported in WO/2017/219143 and WO 2020/237381. Accordingly, the present disclosure provides for methods and systems of continuous forming which overcome these processing challenges and enable manufacturing products at high production rates (e.g., pulling rates on the order of ft/min) without need for complex systems.

In one aspect, the present disclosure is directed to a method for manufacturing thermoplastic products (e.g., continuous fiber thermoplastic composite parts) from a feed material. In many embodiments, the method includes the steps of: i) providing the feed material; ii) heating the feed material to a first temperature to produce a heated feed material, wherein the first temperature is above the glass transition temperature of at least one component of the feed material; iii) forming a consolidated material from the heated feed material; and iv) cooling the consolidated material to a second temperature.

In some embodiments, providing the feed material includes: i) pulling each of the feed material, heated feed material, and consolidated material through each of steps i), ii), iii), and iv); and/or ii) controlling a tension force on the feed material (e.g., by applying a tension force to the feed material by a tensioning unit).

In some embodiments, the feed material is a continuous fiber thermoplastic composite material including: i) a fiber component; ii) a thermoplastic component; iii) a functional component; or iv) any combination thereof. In some embodiments, the fiber component and the thermoplastic component are commingled.

In some embodiments, fiber components comprise a fiber selected from: i) glass fiber (e.g., E-glass); ii) carbon fiber; iii) aramid fiber; iv) basalt fiber; v) organic fiber (e.g., hemp fiber, e.g., wood-derived fiber; and vi) any combination thereof.

In some embodiments, the thermoplastic component comprises a thermoplastic polymer. For example, in some embodiments, the thermoplastic component comprises a thermoplastic polymer selected from the group consisting of: polyethylene terephthalate (PET), polyethylene terephthalate glycol (PETg), polycarbonate, polyethylene (e.g., high-density polyethylene (HDPE), e.g., low-density polyethylene (LDPE)), polypropylene, polyetheretherketone, polyaryletherketone (e.g., low melt polyaryletherketone), polyamide (e.g., nylon 6, nylon 6 6, nylon 6 12, nylon 4,6 nylon 12, etc.), acrylonitrile butadiene styrene, polylactic acid, polyvinylchloride, or any combination thereof.

In some embodiments, disclosed methods further comprise finishing the thermoplastic product. For example, in some embodiments, finishing includes: i) surfacing; (e.g., deforming a surface of the thermoplastic product); ii) filament winding; iii) tape winding; iv) bending; v) curving; vi) cutting; or vii) any combination thereof.

In some embodiments, disclosed methods do not comprise saturating the fiber component with the thermoplastic component.

In some embodiments, the thermoplastic product is selected from: reinforcing bar (e.g., rebar), a plate (e.g., a flat plate), an I-beam, a Pi preform, a structural angle, a structural channel (e.g., a C-channel), a hollow structural section, and a pipe.

In some embodiments, heating the feed material includes subjecting the feed material to at least one heating source. In some embodiments, the at least one heating source is selected from the group consisting of: a) a radiative heater; b) a convective heater; c) an inductive hater; and d) a resistance heater; or e) any combination thereof.

In some embodiments, forming the consolidated material from the heated feed material includes: i) collecting at least a portion of the heated feed material at the first temperature; ii) optionally heating the heated feed material to a third temperature; iii) optionally cooling the heated feed material to a fourth temperature; and iv) applying pressure (e.g., applying a consolidation pressure) to the heated feed material.

In some embodiments, applying pressure to the heated feed material is performed substantially simultaneously with at least one of i), ii), and/or iii).

In some embodiments, the third temperature is intermediate of the first temperature and the second temperature.

In some embodiments, after forming the consolidated material from the heated feed material, the consolidated material has a cross-section (e.g., a cross-section dimension, e.g., a cross-section shape) different than a cross-section of the heated feed material.

In some embodiments, cooling the consolidated material comprises: i) initially cooling the consolidated material to (a) below the glass transition temperature of the feed material or (b) below the melt transition temperature of the feed material; and/or ii) subsequently cooling the consolidated material to ambient temperature (e.g., room temperature).

In another aspect, the present disclosure is directed to a continuous forming machines for manufacturing thermoplastic products from a feed material. In many embodiments, a continuous forming machine comprises: i) a loading unit; ii) a tensioning unit; iii) a heating unit; iv) a forming unit; v) a cooling unit; and vi) a pulling unit, wherein the continuous forming machine is capable of using feed materials comprising thermoplastic materials.

In some embodiments, the machine does not comprise: (i) a saturating unit; and/or (ii) a vacuum unit. For example, in some embodiments, the machine does not comprise a saturating unit selected from the group consisting of: a resin bath saturating unit, a resin injection saturating unit, and a combination of both.

In some embodiments, the feed material is a continuous fiber thermoplastic composite material comprising: i) a fiber component; ii) a thermoplastic component; iii) a functional component; or iv) any combination thereof, wherein the fiber component and the thermoplastic component are commingled.

In some embodiments, the fiber component comprises a fiber selected from the group consisting of: i) glass fiber (e.g., E-glass); ii) carbon fiber; iii) aramid fiber; iv) basalt fiber; v) organic fiber (e.g., hemp fiber, e.g., wood-derived fiber; and vi) any combination thereof.

In some embodiments, the thermoplastic component comprises a thermoplastic polymer selected from the group consisting of: polyethylene terephthalate (PET), polyethylene terephthalate glycol (PETg), polycarbonate, polyethylene (e.g., high-density polyethylene (HDPE), e.g., low-density polyethylene (LDPE)), polypropylene, polyetheretherketone, polyaryletherketone (e.g., low melt polyaryletherketone), polyamide (e.g., nylon 6, nylon 6 6, nylon 6 12, nylon 4,6 nylon 12, etc.), acrylonitrile butadiene styrene, polylactic acid, polyvinylchloride, or any combination thereof.

In some embodiments, the loading unit stores at least 1, at least 5, at least 10, at least 15, at least 20, at least 25, at least 30, at least 35, at least 40, at least 45, at least 50 storage modules (e.g., spools, e.g., bobbins, e.g., reels, e.g., coils) of the feed material.

In some embodiments, the heating unit comprises at least one heating source. For example, in some embodiments, the at least one heating source is selected from the group consisting of: a radiative heater, a convective heaters, an inductive heater, a resistance heater, or any combination thereof.

In some embodiments, the forming unit comprises a collecting unit and at least one consolidating die.

In some embodiments, the pulling unit is selected from the group consisting of: a reciprocating pulling unit and a traction pulling unit.

In some embodiments, the pulling unit pulls the feed material at a rate within a range of about 0.1 ft/min to about 200 ft/min, at a rate within a range of about 0.1 ft/min to about 15 ft/min, or at a rate within a range of about 1 ft/min to about 10 ft/min.

In some embodiments, the machine further comprises: i) a thermoplastic injecting unit, ii) a roll forming unit, iii) a surface reforming unit, iv) a tape/filament winding unit, v) a bending/curving unit, vi) a conveying unit, vii) a cutting unit, and viii) any combination thereof.

In some embodiments, the thermoplastic product is selected from the group consisting of: reinforcing bar (e.g., rebar), a plate (e.g., a flat plate), an I-beam, a Pi preform, a structural angle, a structural channel (e.g., a C-channel), a hollow structural section, and a pipe.

### BRIEF DESCRIPTION OF THE DRAWING

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1A shows a non-limiting, illustrative embodiment of a continuous forming machine 100;

FIG. 1B shows a perspective view of a non-limiting, illustrative embodiment of a continuous forming machine 100;

FIG. 1C shows a perspective view of a non-limiting, illustrative embodiment of a continuous forming machine 100;

FIG. 2A shows a non-limiting, illustrative embodiment of a loading unit 200;

FIG. 2B shows a non-limiting, illustrative embodiment of a loading unit 200;

FIG. 2C shows a non-limiting, illustrative embodiment of a loading unit 200 and a non-limiting illustrative embodiment of a tensioning unit 300;

FIG. 3A shows a non-limiting, illustrative embodiment of a tensioning unit 300;

FIG. 3B shows a non-limiting, illustrative embodiment of a tensioning unit 300;

FIG. 4A shows a non-limiting, illustrative embodiment of a heating unit 400;

FIG. 4B shows a non-limiting, illustrative embodiment of a heating unit 400;

FIG. 5A shows a non-limiting, illustrative embodiment of a forming unit 500 comprising a collecting unit 510 and at least one consolidating die 520;

FIG. 5B shows a non-limiting, illustrative embodiment of a forming unit 500 associated with an exemplary cooling die 700, the exemplary forming unit 500 comprising a collecting unit 510 and consolidating unit (e.g., consolidating dies) 520 and 522;

FIG. 6 shows a non-limiting, illustrative embodiment of a heat rejection unit 530, which may be used with a forming unit 500 in accordance with disclosed embodiments;

FIG. 7 shows a non-limiting, illustrative embodiment of a cooling die 700;

FIG. 8 shows a non-limiting, illustrative embodiment of a cooling unit 800, for example a flood cooling unit;

FIG. 9 shows an exemplary meshing model for heat transfer in an exemplary consolidating die 500;

FIG. 10 shows an exemplary temperature profile of an exemplary consolidating die;

FIG. 11 shows an exemplary temperature profile of an exemplary consolidating die;

FIG. 12 shows an exemplary embodiment of a pulling unit 1400, for example a reciprocating puller;

FIG. 13 shows an exemplary embodiment of a pulling unit 1400, for example a traction puller;

FIG. 14A shows an illustrative embodiment of a pulling unit 1400 comprising a traction puller 1410;

FIG. 14B shows a perspective view of an illustrative embodiment of a traction puller 1410 included in an exemplary pulling unit 1400;

FIG. 14C shows a perspective view of an illustrative embodiment of a traction puller 1410 included in an exemplary pulling unit 1400;

FIG. 14D shows a perspective view of an illustrative embodiment of a traction puller 1410 included in an exemplary pulling unit 1400;

FIG. 14E shows a perspective view of an illustrative embodiment of a traction puller 1410 included in an exemplary pulling unit 1400;

FIG. 15A shows a perspective view of an illustrative embodiment of a roll former 1500 included in an exemplary continuous forming machine;

FIG. 15B shows a perspective view of an illustrative embodiment of a roll former 1500 included in an exemplary continuous forming machine 100;

FIG. 16A shows an exemplary thermoplastic product produced by an exemplary method disclosed herein;

FIG. 16B shows an exemplary thermoplastic product produced by an exemplary method disclosed herein;

FIG. 16C shows an exemplary roll former useful for producing an exemplary thermoplastic product;

FIG. 17A shows a perspective view of an exemplary filament winder useful for imparting surfaces on embodiments of thermoplastic products;

FIG. 17B shows a perspective view of an exemplary filament winder useful for imparting surfaces on embodiments of thermoplastic products;

FIG. 18A shows a perspective view of an illustrative embodiment of an apparatus, included in an exemplary continuous forming machine, useful for imparting curvature onto embodiments of thermoplastic products; and

FIG. 18B shows a perspective view of an illustrative embodiment of an apparatus, included in an exemplary continuous forming machine, useful for imparting curvature onto embodiments of thermoplastic products.

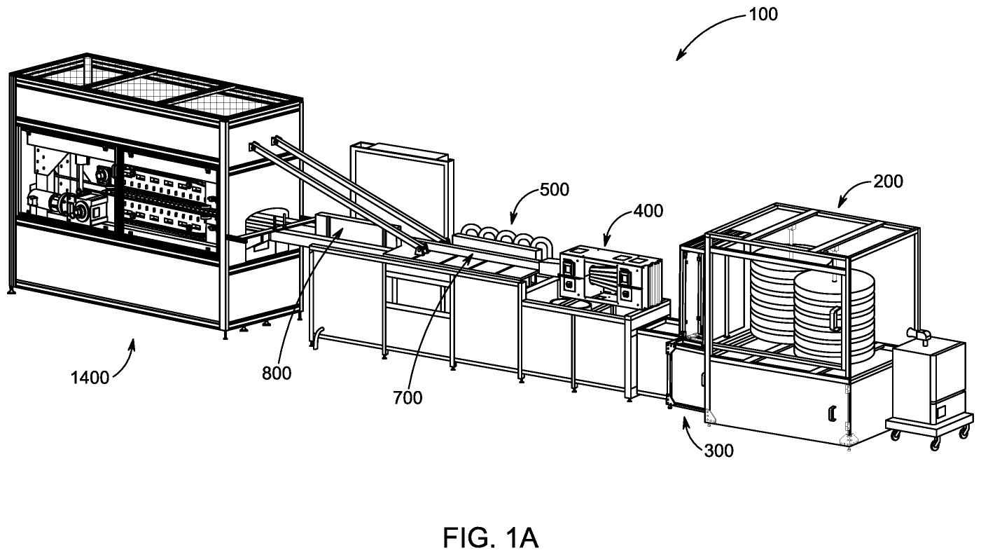

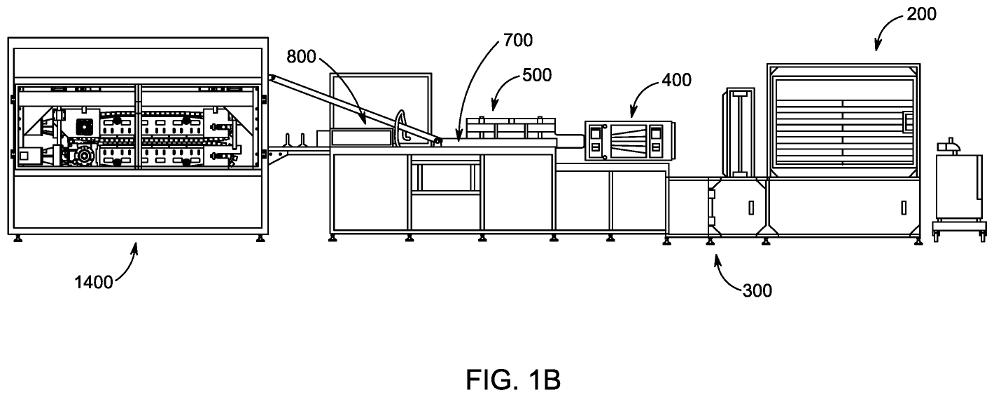

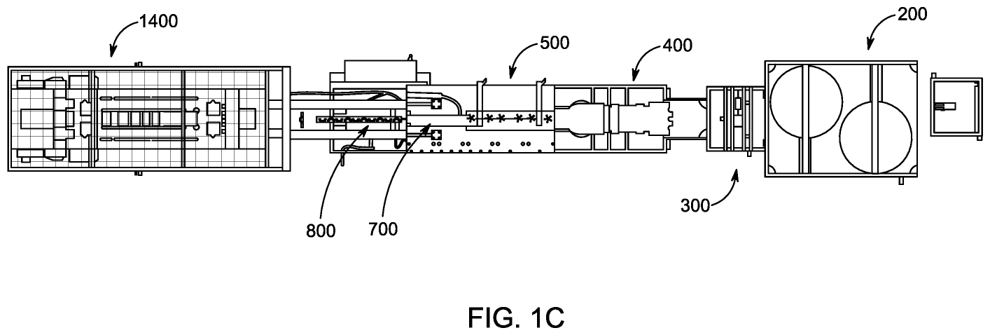

### DEFINITIONS

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Comprising: A composition or method described herein as “comprising” one or more named elements or steps is open-ended, meaning that the named elements or steps are essential, but other elements or steps may be added within the scope of the composition or method. To avoid prolixity, it is also understood that any composition or method described as “comprising” (or which “comprises”) one or more named elements or steps also describes the corresponding, more limited composition or method “consisting essentially of” (or which “consists essentially of”) the same named elements or steps, meaning that the composition or method includes the named essential elements or steps and may also include additional elements or steps that do not materially affect the basic and novel characteristic(s) of the composition or method. It is also understood that any composition or method described herein as “comprising” or “consisting essentially of” one or more named elements or steps also describes the corresponding, more limited, and closed-ended composition or method “consisting of” (or “consists of”) the named elements or steps to the exclusion of any other unnamed element or step. In any composition or method disclosed herein, known or disclosed equivalents of any named essential element or step may be substituted for that element or step.

Glass Transition: As used herein, “glass transition” is the gradual and reversible transition from a hard and relatively brittle “glassy” state into a viscous or rubbery state in amorphous materials, or in amorphous regions within semicrystalline materials, when temperature is increased. The “glass transition” of a material is a phenomenon extending over a temperature range and thus is not to be construed as always occurring at a singular temperature. As used herein, the “glass transition temperature” of a material refers to the temperature below which the material is characterized as a hard and relatively brittle “glassy”. Accordingly, as the temperature of the material is increased above its “glass transition temperature”, the material will undergo its transition to a rubbery, malleable state over said temperature range. Any number of material property data references, databases, and/or handbooks may be used to identify the “glass transition” and/or “glass transition temperature” for materials disclosed herein, such as Brandrup J et al. Polymer Handbook 4th Edition. 4th ed. Wiley 2004.

Melt Transition: As used herein, “melt transition” is the thermodynamic transition from the structured, crystalline state to the melt state in crystalline materials, or in crystalline regions within semicrystalline materials, when temperature is increased. Accordingly, as used herein, the “melt transition temperature”, “melting temperature”, or “melting point” of a material refers to the temperature at which the material exhibits its “melt transition”. Any number of material property data references, databases, and/or handbooks may be used to identify the “melt transition temperature” for materials disclosed herein, such as Brandrup J et al. Polymer Handbook 4th Edition. 4th ed. Wiley 2004.

### DETAILED DESCRIPTION OF CERTAIN EMBODIMENTS

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps.

It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between.

Headers are provided for the convenience of the reader and are not intended to be limiting with respect to the claimed subject matter.

### I. Methods for Manufacturing Thermoplastic Products

The present disclosure provides, among other things, methods and systems for manufacturing thermoplastic products (e.g., continuous fiber thermoplastic composite parts) from feed materials. By way of non-limiting example, manufacturing thermoplastic products comprises providing feed materials, heating feed materials to produce heated feed materials, forming consolidate materials from heated feed materials and cooling consolidated materials.

### A. Exemplary Feed Materials

In accordance with various embodiments, feed materials of the present disclosure may be selected for any application-appropriate manner. By way of non-limiting example, feed materials may be continuous fiber thermoplastic composite materials. For example, in some embodiments, continuous fiber thermoplastic composite materials comprise: i) fiber components; ii) thermoplastic components; iii) functional components; or iv) any combination thereof. In some embodiments, fiber components and thermoplastic components are commingled. For example, feed materials may be characterized as being pre-impregnated (e.g., “pre-preg”) or semi-impregnated (e.g., “semi-preg”).

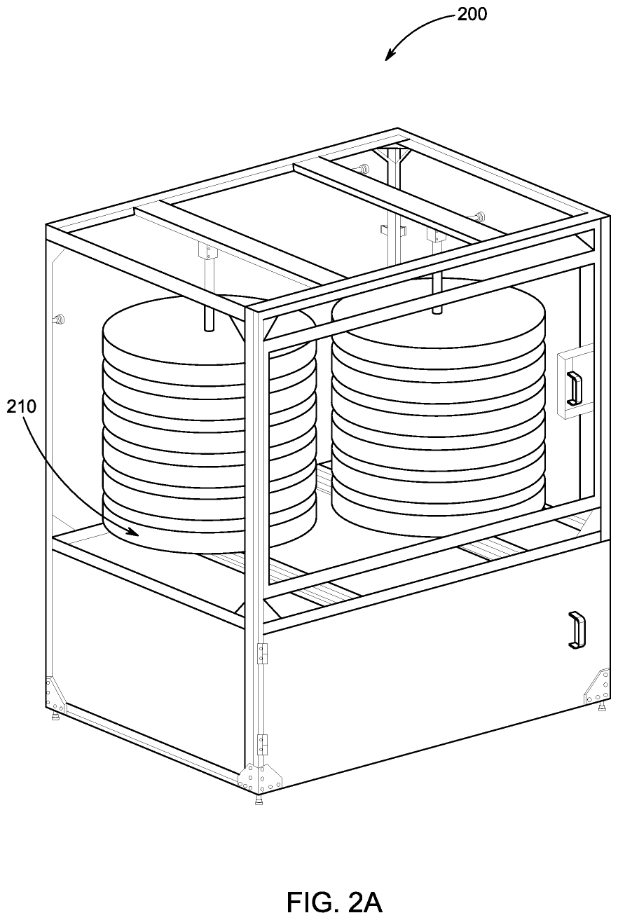

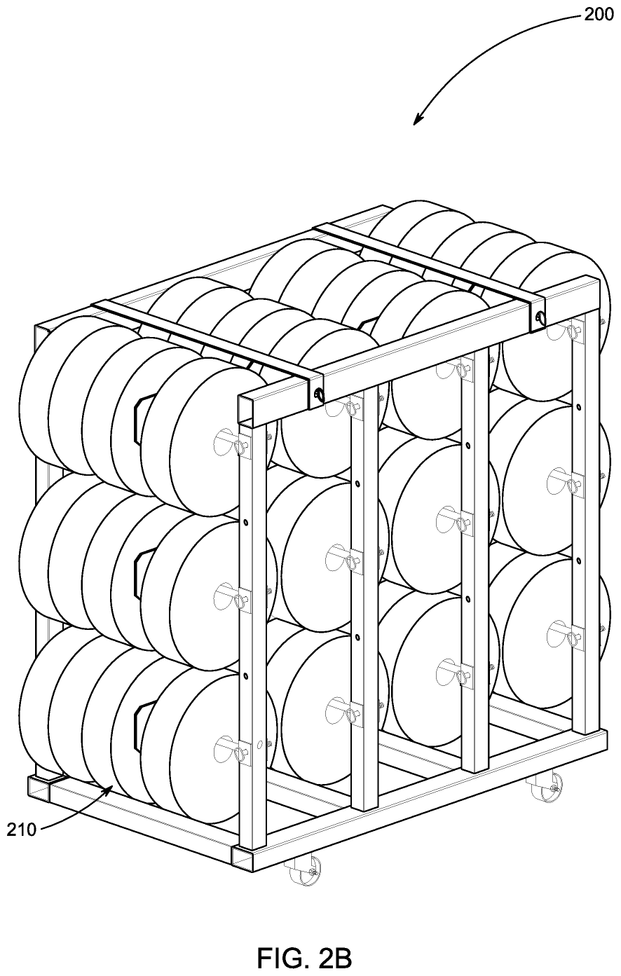

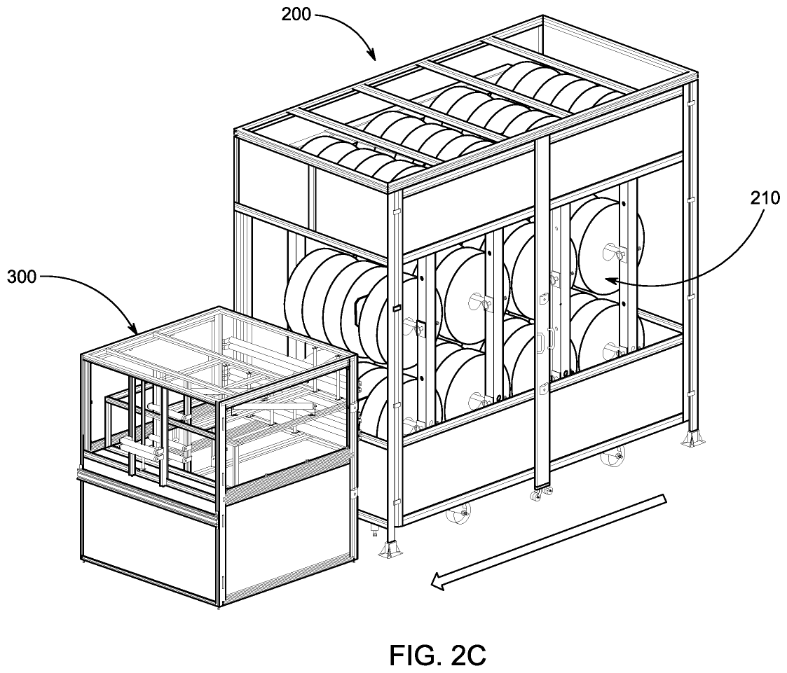

Further, feed materials may be in any application-appropriate form. By way of non-limiting example, feed materials may be characterized as tapes (e.g., unidirectional tapes), fibers (e.g., commingled fibers), fabrics (e.g., preimpregnated fabrics), or towpregs (e.g., pre-impregnated reinforcement fibers). Non-limiting embodiments of exemplary tapes of feed materials 210 are presented at least in FIGS. 2A-2C.

i. Fiber Components

In accordance with various embodiments, fiber components of a feed material may be selected for any application-appropriate manner. By way of non-limiting example, fiber components may be naturally-derived fiber materials and/or synthetically-derived fiber materials. In many embodiments, exemplary fiber components include, but are not limited to, glass fibers (e.g., E-glass), carbon fibers, aramid fibers, basalt fibers, organic fibers (e.g., hemp fibers, e.g., wood-derived fibers), or any combination thereof.

ii. Thermoplastic Components

In accordance with various embodiments, thermoplastic components may be selected for any application-appropriate manner. By way of non-limiting example, thermoplastic components are thermoplastic polymers. In some embodiments, thermoplastic polymers may be characterized as amorphous. In some embodiments, thermoplastic polymers may be characterized as semicrystalline, comprising both amorphous components and crystalline components.

In many embodiments, exemplary thermoplastic polymers include but are not limited to polyethylene terephthalate (PET), polyethylene terephthalate glycol (PETg), polycarbonate, polyethylene (e.g., high-density polyethylene (HDPE), e.g., low-density polyethylene (LDPE)), polypropylene, polyetheretherketone, polyaryletherketone (e.g., low melt polyaryletherketone), polyamide (e.g., nylon 6, nylon 6 6, nylon 6 12, nylon 4,6 nylon 12, etc.), acrylonitrile butadiene styrene, polylactic acid, polyvinylchloride, or any combination thereof.

iii. Functional Components

In some embodiments, feed materials may further comprise functional components, which may enhance part functionality and/or performance. For example, additional components may include inductive materials which are useful in bending exemplary continuous fiber thermoplastic composite parts after forming. Exemplary functional components may include susceptor materials (e.g., for use in inductive heating, such as microwave or radiofrequency heating); conductive materials (e.g., conductors or conductive mesh for use in resistive heating); metallic film or foil materials (e.g., for use as EMI shielding); surfacing materials such as dry fibers, fabric, and/or paper; filler or coating materials such as neat thermoplastic resin, foamed thermoplastic resin, or expanding foam; embedded sensors such as thermocouples or similar to detect and transmit conditions within thermoplastic products; or any combination thereof.

b. Providing Feed Materials

In accordance with various embodiments, methods and systems for manufacturing thermoplastic products (e.g., continuous fiber thermoplastic composite parts) from feed materials comprises providing one or more feed materials. By way of non-limiting example, providing feed materials comprises: i) pulling feed materials, heated feed materials, and/or consolidated materials; and ii) controlling a tension force on feed materials.

i. Pulling

In many embodiments, providing feed materials comprises pulling i) feed materials, ii) heated feed materials, and/or iii) consolidated materials. One of skill in the art will appreciate that any of feed materials, heated feed materials, and consolidated materials will actually be pushed through certain steps and/or units of provided systems because they are located after pulling units.

In accordance with various embodiments, any of a variety of methods may be used to pull feed materials, heated feed materials, and/or consolidated materials into or through provided systems. For example, in some embodiments, exemplary pulling units 1400 provide pulling forces necessary to pull each of feed materials, heated feed materials, consolidated materials, and thermoplastic products into and through disclosed systems. Such pulling forces necessary may depend on tension forces applied by exemplary tensioning units 300. In some embodiments, exemplary pulling units provide pulling forces up to about 1 lbs, up to about 10 lbs, up to about 100 lbs, up to about 1,000 lbs, up to about 10,000 lbs, up to about 100,000 lbs, up to about 1,000,000 lbs.

In some embodiments, each of feed materials, heated feed materials, consolidated materials, and thermoplastic products move substantially continuously (e.g., are pulled substantially continuously) through each materials' respective steps or units of disclosed methods and systems. For example, each of feed materials, heated feed materials, consolidated materials, and thermoplastic products move substantially continuously (e.g., are pulled substantially continuously) at a rate within a range of about 0.1 ft/min to about 200 ft/min, at a rate within a range of about 0.1 ft/min to about 15 ft/min, or at a rate within a range of about 1 ft/min to about 10 ft/min.

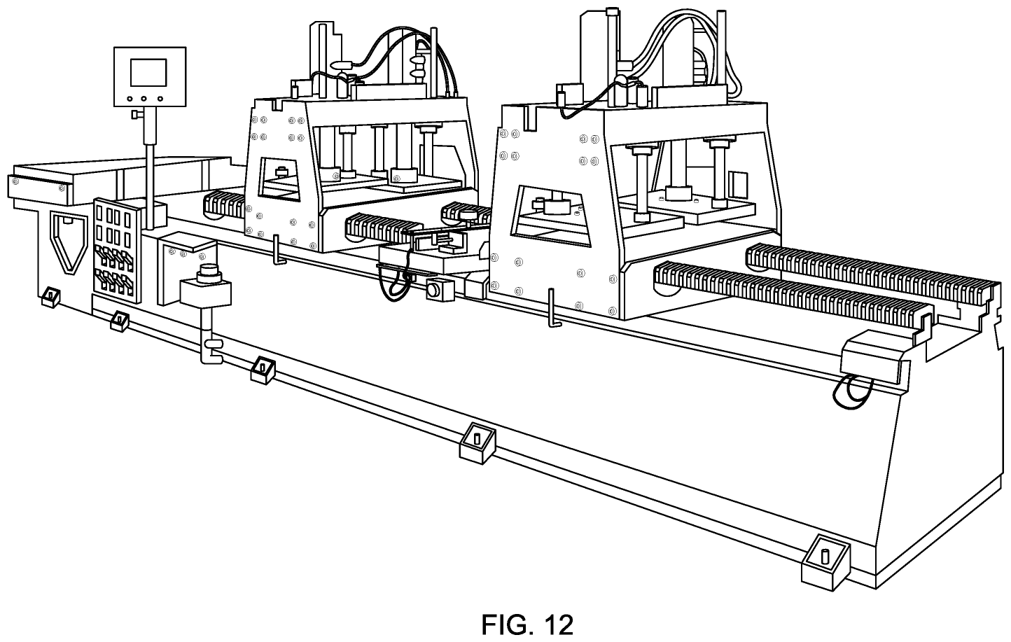

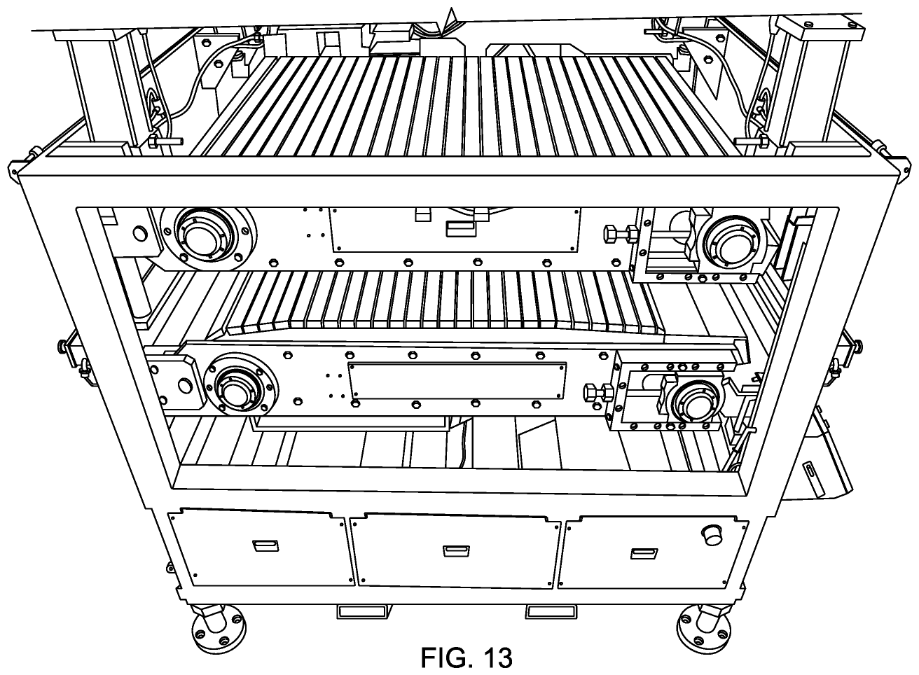

In many embodiments, pulling is performed by a pulling unit 1400. For example, in some embodiments, a pulling unit 1400 may include a reciprocating puller, exemplified in a non-limiting embodiment in FIG. 12. Exemplary reciprocating pullers may comprise two independent hydraulic grippers that pinch processed materials (e.g., consolidated materials and/or thermoplastic products) and pull them forward using a hydraulic ram, each hydraulic gripper moving in alternating directions so that one is always pulling processed materials continuously.

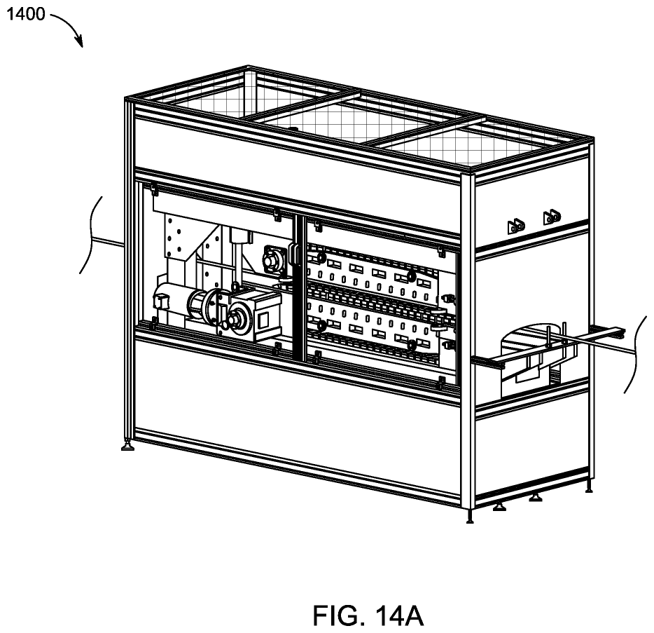

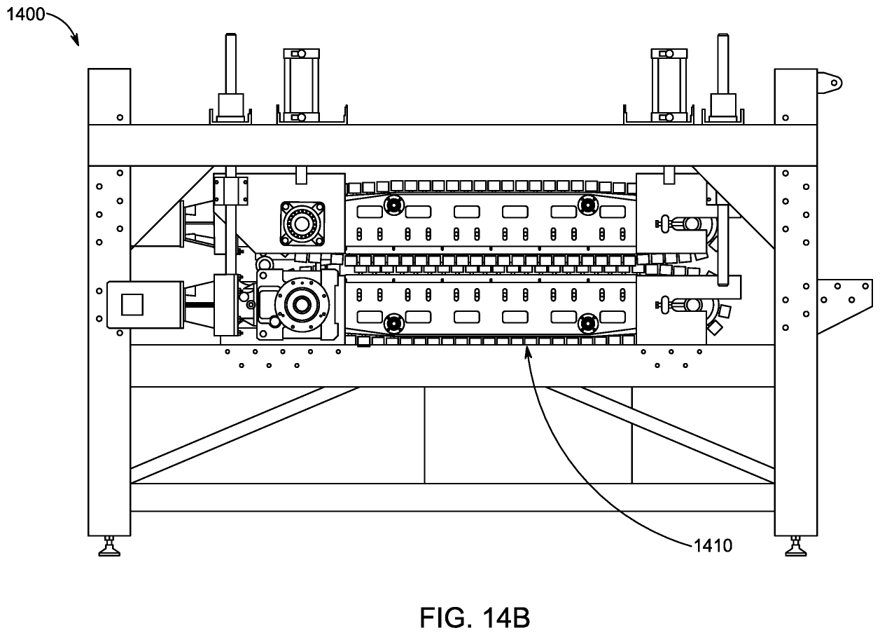

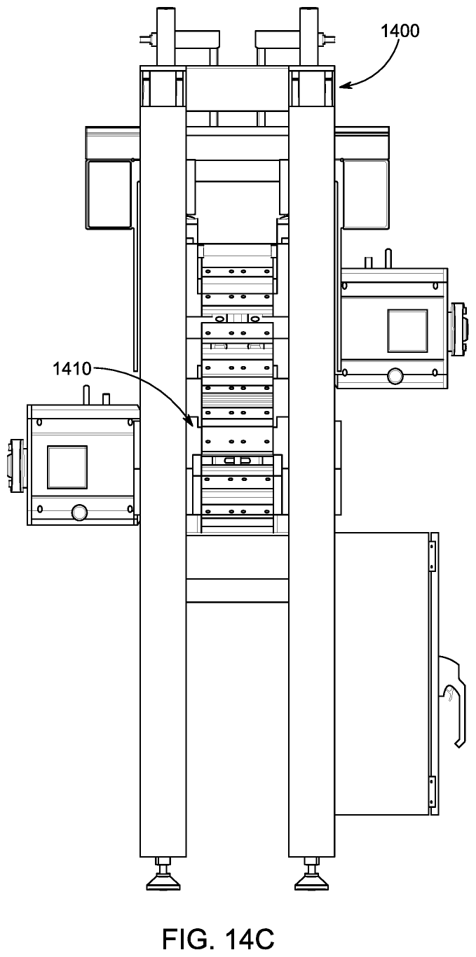

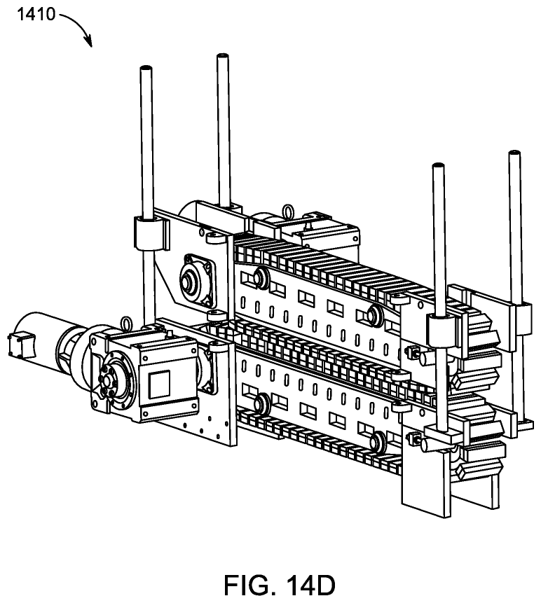

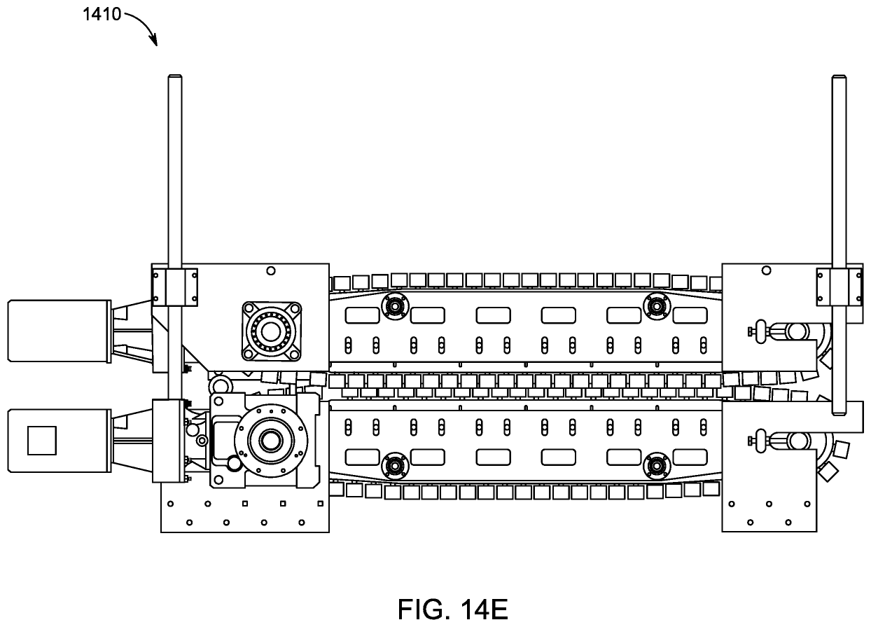

In some embodiments, a pulling unit 1400 may include a traction puller 1410, exemplified in non-limiting embodiments in FIG. 13 and FIGS. 14A-14E. In some embodiments, an exemplary traction puller comprises two opposing tracks that grip onto processed materials (e.g., consolidated materials, e.g., thermoplastic products) and pull disclosed materials (e.g., each of feed materials, heated feed materials, consolidated materials, and thermoplastic products) at exemplary rates disclosed herein.

In many embodiments, providing feed material further comprises pulling feed materials from loading units 200 (e.g., creel units), exemplified in non-limiting embodiments in FIGS. 2A-2C. Exemplary loading units 200 provide for storing exemplary feed materials 210 and/or provide for uniform distribution of feed materials through disclosed methods and systems.

Further, exemplary loading units 200 provide for application-appropriate design considerations. By way of non-limiting example, loading units 200 may be appropriately sized and designed for thermoplastic product manufacturing requirements. For example, design considerations may include thermoplastic product geometry (e.g., cross-section dimension and/or shape) and/or thermoplastic product throughput needs (e.g., to provide for ease in manufacturing scale-up requirements). One of skill in the art will appreciate that the capability for such design considerations allow for advantageous scale-up of thermoplastic product manufacturing needs.

In some embodiments, exemplary loading units 200 enable storage and feeding of at least 1, at least 5, at least 10, at least 15, at least 20, at least 25, at least 30, at least 35, at least 40, at least 45, at least 50 storage modules (e.g., spools, e.g., bobbins, e.g., reels, e.g., coils) of exemplary feed materials 210.

In some embodiments, exemplary loading units 200 enable storage of and feeding of storage modules (e.g., spools, e.g., bobbins, e.g., reels, e.g., coils) of exemplary feed materials 210, wherein exemplary storage modules (e.g., spools, e.g., bobbins, e.g., reels, e.g., coils) have a diameter of at most about 5 inches, at most about 10 inches, at most about 15 inches, at most about 20 inches, at most about 25 inches, at most about 30 inches, at most about 35 inches, at most about 40 inches, at most about 45 inches, or at most about 50 inches.

In some embodiments, exemplary loading units 200 enable storage and feeding of storage modules (e.g., spools, e.g., bobbins, e.g., reels, e.g., coils) of feed materials 210 may have a width of at most about 1 inch, at most about 2 inches, at most about 5 inches, at most about 10 inches, at most about 15 inches, at most about 20 inches, at most about 25 inches, at most about 30 inches, at most about 35 inches, at most about 40 inches, at most about 45 inches, at most about 50 inches, or at most about 55 inches.

In some embodiments, exemplary loading units 200 enable storage of storage modules (e.g., spools, e.g., bobbins, e.g., reels, e.g., coils) of feed materials 210 in a vertically-stacked manner, exemplified in FIG. 2A or in a horizontally-stacked manner, exemplified in FIG. 2B.

ii. Tensioning

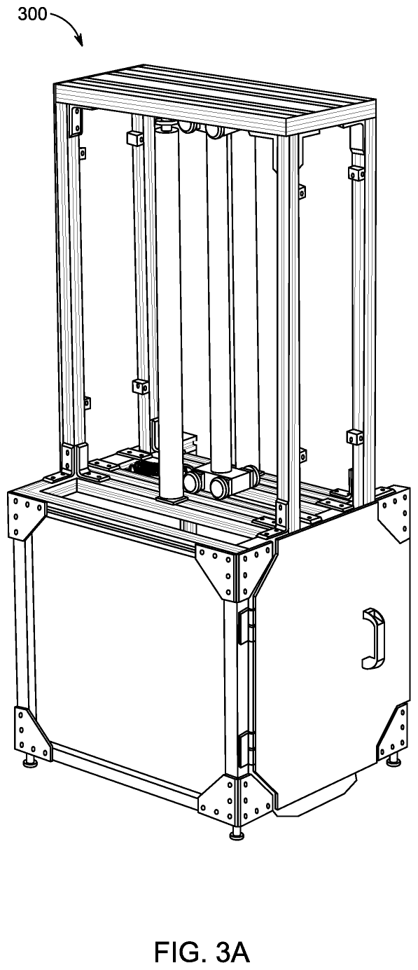

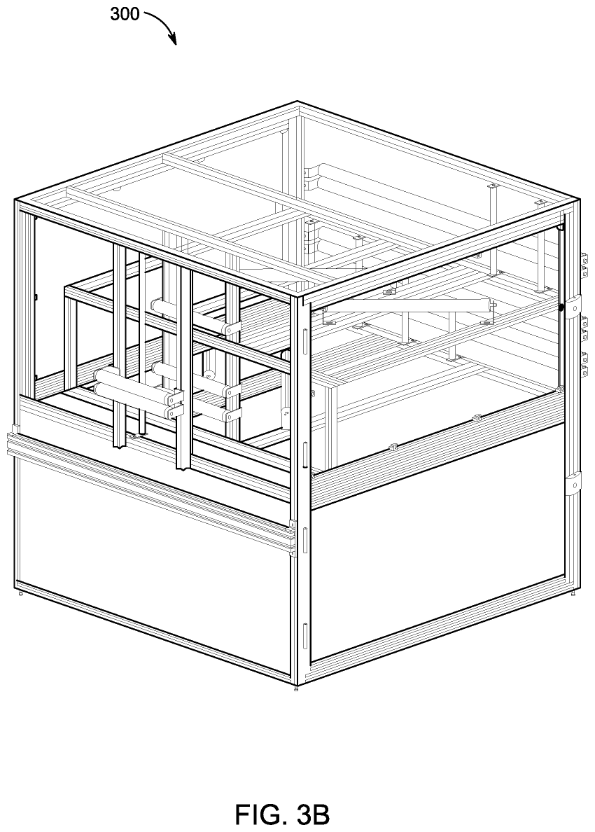

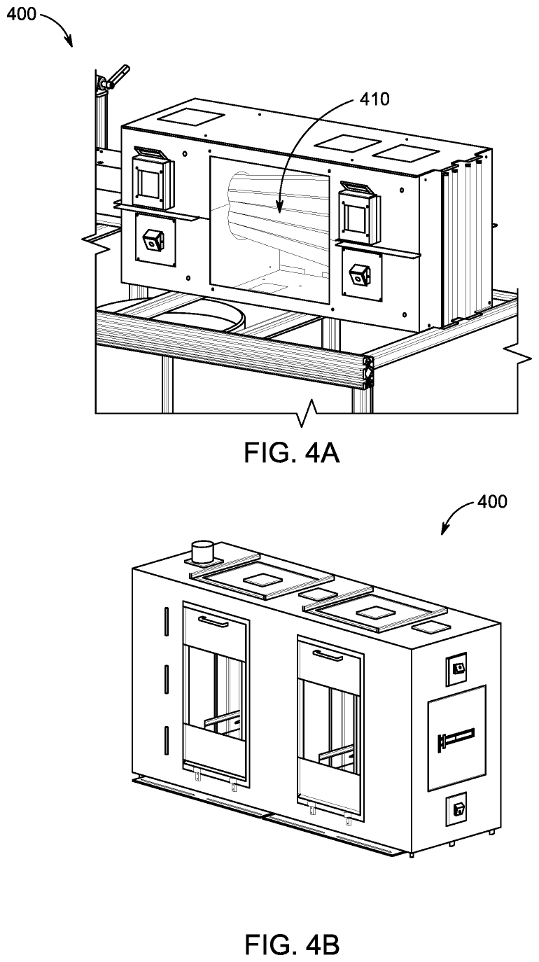

In accordance with various embodiments, controlling tension forces on feed materials may be performed in any application-appropriate manner. By way of non-limiting example, controlling tension forces includes applying a tension force to feed materials using exemplary tensioning units 300, exemplified in FIGS. 3A and 3B. For example, in some embodiments, exemplary tensioning units 300 may include fixed cylinders and compressed cylinders having a linear rail and spring system. In some embodiments, exemplary tensioning units 300 may include braking systems (e.g., braking calipers at storage modules) which provide for accurate and/or consistent tension via closed-loop control, or braking systems which provide for a minimum tension via passive control.

Additionally or alternatively, use of exemplary tensioning units 300 enables arrangement of feed materials, which enables manufacturing thermoplastic products having varying cross-section geometries and/or dimensions. In some embodiments, rearrangement of feed materials may be controlled by adjustable rollers included in exemplary tensioning units 300.

c. Heating

In accordance with various embodiments, any of a variety of methods may be used to heat feed materials. By way of non-limiting example, heating feed materials comprises heating feed materials to a first temperature to produce heated feed materials. To process exemplary materials of the present disclosure, thermoplastic components must not be in the rigid, glassy state. Accordingly, a first temperature may be selected based on properties inherent to thermoplastic components of exemplary feed materials. For example, a first temperature may be determined based on the glass transition temperature inherent to thermoplastic components of exemplary feed materials. As such, in some embodiments, a first temperature is above the glass transition temperature of at least one component (e.g., at least one thermoplastic component) of feed materials.

In many embodiments, a first temperature may be selected based on the extent to which the glass transition temperature of exemplary thermoplastic components may be exceeded. Considerations for the extent to which the glass transition temperature may be exceeded include controlling the viscosity of exemplary thermoplastic components for processing and/or preventing degradation of exemplary feed materials. For example, marginally exceeding the glass transition temperature of thermoplastic components may not enable sufficient viscosity for processing (e.g., too low of viscosity would not allow for proper material flow through the system). Alternatively, greatly exceeding the glass transition temperature of thermoplastic components may cause too low of a viscosity for processing and/or may cause degradation of any of feed material components. One of skill in the art will appreciate that such considerations may vary between thermoplastic components utilized according to various embodiments of the present disclosure.

In some embodiments, a first temperature is greater than the glass transition temperature of thermoplastic components of exemplary feed materials by at least about 5° F., by at least about 10° F., by at least about 20° F., by at least about 30° F., by at least about 40° F., by at least about 50° F., by at least about 60° F., by at least about 70° F., by at least about 80° F., by at least about 90° F., by at least about 100° F., by at least about 110° F., by at least about 120° F., by at least about 130° F., by at least about 140° F., by at least about 150° F., by at least about 160° F., by at least about 170° F., by at least about 180° F., by at least about 190° F., by at least about 200° F., by at least about 210° F., by at least about 220° F., by at least about 230° F., by at least about 240° F., by at least about 250° F., by at least about 260° F., by at least about 270° F., by at least about 280° F., by at least about 290° F., by at least about 300° F., by at least about 310° F., by at least about 320° F., by at least about 330° F., by at least about 340° F., by at least about 350° F., by at least about 360° F., by at least about 370° F., by at least about 380° F., by at least about 390° F., by at least about 400° F., by at least about 410° F., by at least about 420° F., by at least about 430° F., by at least about 440° F., by at least about 450° F., by at least about 460° F., by at least about 470° F., by at least about 480° F., by at least about 490° F., or by at least about 500° F.

In a non-limiting example according to various embodiments of the present disclosure, when PETg is utilized as a thermoplastic component of an exemplary feed material, a first temperature may be about 350° F., which is about 174° F. greater than the glass transition temperature of PETg.

In accordance with various embodiments of the present disclosure, heating may performed by any of a variety of heating units. By way of non-limiting example, heating may be performed using exemplary heating units 400 (e.g., a preheater) to increase the bulk temperature of feed materials 410 from room temperature to a temperature close to or equal to a first temperature.

In some embodiments, exemplary heating units 400 comprise at least one heating source. Utilizing at least one heating source enables evenly and accurately heating exemplary feed materials. For example, an exemplary heating unit 400 may comprise three heating sources (e.g., three infrared heating sources) to assist in improving heating efficiency. Without wishing to be bound by any particular theory, in some embodiments, multiple heating sources allow for heat to diffuse through feed materials in between each heating source Exemplary heating sources include any of radiative heaters, convective heaters, inductive heaters, resistance heaters, or any combination thereof. Without wishing to be held to a particular theory, in some embodiments, it may be advantageous to use convective heating, for example, because this mode of heating efficiently redistributes heat to sections of the feed materials that may have been occluded from a particular heating element or step (e.g., due to distance between heat source and portion of feed material).

In some embodiments, heating sources may be configured to provide for rapid heating and/or precise temperature control. Rapid heating enables high production throughput and/or fast response to input changes. Precise temperature control enables quality control and to control heating rates warranted for some components of feed materials. Without wishing to be by bound by any particular theory, in some embodiments, alteration of temperature control systems can provide a trade-off between rapid heating modes (which may overshoot or undershoot a target temperature) and more precise heating control (which is slower in function (and hence relies on previous, more powerful stages) but more accurate and precise in target temperature. Exemplary input changes may include increasing or decreasing feed material input rates (e.g., increasing or decreasing feed material pulling speeds, e.g., increasing or decreasing feed material mass rates, e.g., including additional feed material components). In some embodiments, such input changes may be advantageous or necessary for a variety of needs, for example (i) during development of a production line to study the behavior of the process and improve the overall performance, (ii) to allow for additional material to be added during startup, (iv) to allow for an intermittent production function such as bending and/or the addition of material in unique and non-lineal locations, such as for targeted reinforcement of a particular region, or (iv) to allow for changing between exemplary feed materials (e.g., to restock an existing spool of feed materials or change the product architecture (e.g., change fiber orientations, e.g., change fiber components, e.g., change thermoplastic components, e.g., include exemplary functional components.))

In some embodiments, radiative heaters are infrared heaters, laser heaters, microwave heaters, radiofrequency heaters, or any other types of radiative heaters known in the art. Without wishing to be bound by any particular theory, infrared heaters may be useful because they are efficient, fast-acting, and compatible with properties of exemplary feed materials. For example, infrared heaters are useful for feed materials being flat tapes with high surface area and/or feed materials which are semi-translucent that transmits a fraction of the infrared radiation from layers of the feed materials.

In some embodiments, convective heating is used to complement infrared heating to aid to provide for a more even temperature distribution as it allows for an additional means of disbursing the heat deposited by infrared radiation. Convective heating may be used as a stand-alone heating source wherein properties of feed materials does not permit heating feed materials (e.g., such as in large tape or fiber bundles) by other heating sources.

In some embodiments, inductive heaters may be used when processing feed materials comprising functional components, such as stainless steel, carbon fiber, aluminum mesh, aluminum fibers, aluminum foil, susceptor materials (e.g., graphite or metal), or other conductive reinforcing materials.

In some embodiments, resistance heaters may be used when processing feed materials comprising functional components, such as stainless steel, carbon fiber, aluminum mesh, aluminum fibers, aluminum foil, susceptor materials (e.g., graphite or metal), Nichrome, Kanthal, or other conductive reinforcing materials. Without wishing to be bound by any particular theory, in some embodiments, resistance heaters may present unique advantages over other heating sources, such as inductive heaters. For example, resistance heaters may advantageous for heating predetermined, targeted regions for additional forming steps.

In some embodiments, exemplary heating units 400 will comprise a thermally reflective material to redirect heat towards feed materials during heating to help minimize losses to the environment, and to provide an even heating pattern. For example, in some embodiments, exemplary infrared heaters may comprise material reflective of applied infrared radiation wavelengths. In some embodiments, exemplary radiation heaters (e.g., microwave and/or radiofrequency heaters) may comprise waveguides which are reflective to target wavelengths that redirect and guide radiation to feed materials.

In some embodiments, a circulation fan may also be utilized to achieve uniform temperature throughout feed materials.

d. Forming

In accordance with various embodiments, any of a variety of methods may be used to form consolidated materials from heated feed materials. By way of non-limiting example, forming consolidated materials from heated feed materials comprises collecting at least a portion of the heated feed materials, optionally heating heated feed materials to a third temperature, optionally cooling heated feed materials to a fourth temperature, and applying pressure. In some embodiments, applying pressure (e.g., a consolidation pressure) to heated feed materials is performed substantially simultaneously with collecting, optional heating, and/or optional cooling. In many embodiments, heated feed materials are collected at a first temperature.

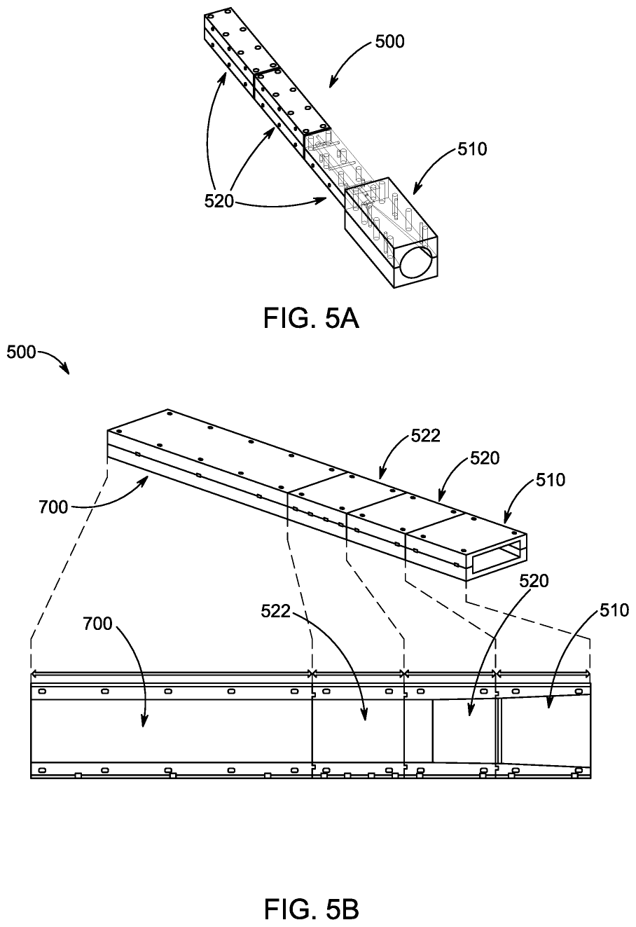

In many embodiments, forming may be performed using exemplary forming units 500. For example, a forming unit may 500 comprise a collecting unit 510 and/or a consolidating unit 520 (e.g., a consolidating die), wherein the collecting unit 510 transitions directly into the consolidating unit 520, exemplified in FIG. 5.

i. Collecting

In many embodiments, collecting at least a portion of heated feed materials at a first temperature is performed using an exemplary collecting unit 510. For example, exemplary collecting units 510 are collecting funnels which assist in providing heated feed materials into exemplary consolidating units 520. Exemplary collecting units 510 are useful for shearing off excess matrix material. For example, in some embodiments, exemplary collecting units 510 remove at most about 0.5 wt %, at most about 1 wt %, at most about 5 wt %, at most about 10 wt %, or at most about 15 wt % of heated feed materials before providing heated feed materials into exemplary consolidating units 520.

ii. Applying Pressure

In accordance with various embodiment, applying pressure may be performed by any of a variety of systems. By way of non-limiting example, in some embodiments, applying a pressure is performed by using exemplary consolidating units 520. For example, an exemplary consolidating unit 520 may be a consolidating die which applies pressure to heated feed materials by tapering heated feed materials to a final cross-section dimension that is less than an initial cross-section dimension to produce consolidated materials. Accordingly, in some embodiments, consolidating units 520 comprise at least one section which tapers to a final cross-section dimension that is less than an initial cross-section dimension.

In some embodiments, exemplary consolidating units 520 comprise consolidating units 522 which have a constant cross-section dimension, exemplified in FIG. 5B.

Additionally, each of at least one section may be separated by spacers (e.g., thin ceramic spacers). For example, a consolidating die may comprise three sections, each with a constant taper in cross-section dimension, providing a continuous taper along the length of the exemplary consolidating unit 520, exemplified in FIG. 5A.

iii. Optional Heating Step During Forming

While forming consolidated materials, in some embodiments, feed materials may require being further heated to temperatures greater than a first temperature. Accordingly, in some embodiments, forming consolidated materials further comprises heating heated feed materials to a third temperature. In accordance with several embodiments, this optional additional heating of heated feed material to a third temperature provides for the bulk temperature of feed materials being at temperature necessary for forming. Without wishing to be bound by any particular theory, because temperature measurement techniques used during heating can be only guarantee a certain precision towards feed material bulk temperature, it may be more efficient to further heat feed material to a third temperature, rather than cool feed material to a third temperature. Further, an intended third temperature is close to the degradation temperature of thermoplastic components of exemplary feed materials, it may be safer to raise the material to the final temperature in the forming process, since the temperature can be controlled more accurately in this zone.

In some embodiments, a third temperature is greater than the glass transition temperature of at least one component (e.g., at least one thermoplastic component) by about at least about 5° F., at least about 10° F., by at least about 20° F., by at least about 30° F., by at least about 40° F., by at least about 50° F., by at least about 60° F., by at least about 70° F., by at least about 80° F., by at least about 90° F., by at least about 100° F., by at least about 110° F., by at least about 120° F., by at least about 130° F., by at least about 140° F., by at least about 150° F., by at least about 160° F., by at least about 170° F., by at least about 180° F., by at least about 190° F., by at least about 200° F., by at least about 210° F., by at least about 220° F., by at least about 230° F., by at least about 240° F., by at least about 250° F., by at least about 260° F., by at least about 270° F., by at least about 280° F., by at least about 290° F., by at least about 300° F., by at least about 310° F., by at least about 320° F., by at least about 330° F., by at least about 340° F., by at least about 350° F., by at least about 360° F., by at least about 370° F., by at least about 380° F., by at least about 390° F., by at least about 400° F., by at least about 410° F., by at least about 420° F., by at least about 430° F., by at least about 440° F., by at least about 450° F., by at least about 460° F., by at least about 470° F., by at least about 480° F., by at least about 490° F., or by at least about 500° F.

In some embodiments, a third temperature is greater than a first temperature by about 10° F., by about 20° F., by about 30° F., by about 40° F., by about 50° F., by about 60° F., by about 70° F., by about 80° F., by about 90° F., by about 100° F., by about 110° F., by about 120° F., by about 130° F., by about 140° F., or by about 150° F.

In a non-limiting example according to various embodiments of the present disclosure, when PETg is utilized as a thermoplastic component of an exemplary feed material, a first temperature may be about 350° F. and a third temperature may be about 400° F., the first temperature being about 174° F. greater than the glass transition temperature of PETg and about 50° F. greater than the first temperature.

In certain embodiments, feed materials comprising semicrystalline thermoplastic components may require forming at a third temperature equal to or greater than the melting temperature of at least one semicrystalline thermoplastic component. Accordingly, in some embodiments, a third temperature is greater than the melt transition temperature of at least one component (e.g., at least one semicrystalline thermoplastic component) by at least about 5° F., at least about 10° F., by at least about 20° F., by at least about 30° F., by at least about 40° F., by at least about 50° F., by at least about 60° F., by at least about 70° F., by at least about 80° F., by at least about 90° F., by at least about 100° F., by at least about 110° F., by at least about 120° F., by at least about 130° F., by at least about 140° F., by at least about 150° F., by at least about 160° F., by at least about 170° F., by at least about 180° F., by at least about 190° F., by at least about 200° F., by at least about 210° F., by at least about 220° F., by at least about 230° F., by at least about 240° F., by at least about 250° F., by at least about 260° F., by at least about 270° F., by at least about 280° F., by at least about 290° F., by at least about 300° F., by at least about 310° F., by at least about 320° F., by at least about 330° F., by at least about 340° F., by at least about 350° F., by at least about 360° F., by at least about 370° F., by at least about 380° F., by at least about 390° F., by at least about 400° F., by at least about 410° F., by at least about 420° F., by at least about 430° F., by at least about 440° F., by at least about 450° F., by at least about 460° F., by at least about 470° F., by at least about 480° F., by at least about 490° F., or by at least about 500° F.

In a non-limiting example according to various embodiments of the present disclosure, when HDPE is utilized as a thermoplastic component of an exemplary feed material, a third temperature may be about 275° F., which is about 440° F. greater than the glass transition temperature of HDPE and about 10° F. greater than the melt temperature of HDPE.

iv. Optional Cooling Step During Forming

In some embodiments, forming consolidated materials may further comprise cooling heated materials to a fourth temperature. For example, exemplary feed materials may require being cooled to temperatures that are less than a third temperature. In some embodiments, a fourth temperature may be less than a third temperature by at least about 5° F., at least about 10° F., by at least about 20° F., by at least about 30° F., by at least about 40° F., by at least about 50° F., by at least about 60° F., by at least about 70° F., by at least about 80° F., by at least about 90° F., by at least about 100° F., by at least about 110° F., by at least about 120° F., by at least about 130° F., by at least about 140° F., by at least about 150° F., by at least about 160° F., by at least about 170° F., by at least about 180° F., by at least about 190° F., by at least about 200° F., by at least about 210° F., by at least about 220° F., by at least about 230° F., by at least about 240° F., or by at least about 250° F.

By way of non-limiting example, and in accordance with various embodiments of the present disclosure, when polyethylene terephthalate glycol (PETg) is utilized as a thermoplastic component of an exemplary feed material, a third temperature may be 400° F. and a fourth temperature may be 325° F.

By way of additional non-limiting example in accordance with various embodiments of the present disclosure, when high density polyethylene (HDPE) is utilized as a thermoplastic component of an exemplary feed material, a third temperature may be approximately 275° F. and a fourth temperature may be approximately 175° F.

In accordance with various embodiments, optional cooling may be performed by any of a variety of methods. By way of non-limiting example, optional cooling may be performed utilizing heat rejection units 530 which are included in exemplary consolidating units 500. In some embodiments, exemplary heat rejection units include flood cooling units, fan cooling units, immersion cooling units, injected fluid cooling units (e.g., either air or liquid coolant injected into an annular space within exemplary cooling units 530), solid state cooling units (e.g., Peltier or other similar thermoelectric devices), internal cooling channel units (e.g., air or liquid coolant fluids flowed through the channels within exemplary cooling units 530.

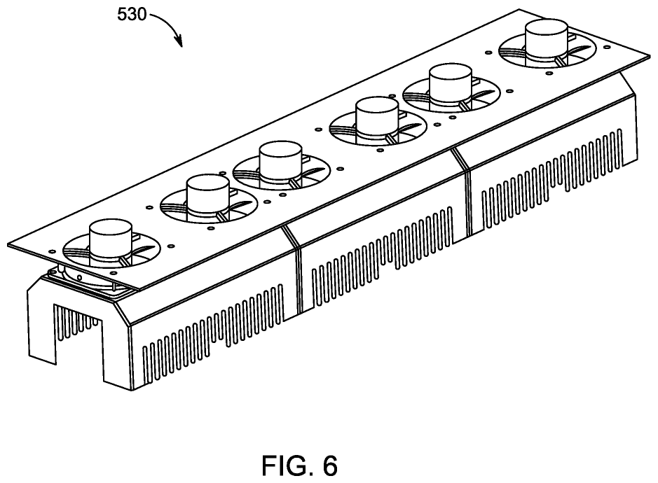

In some embodiments, heat rejection units are associated with (e.g., disposed on at least one terminal section of consolidating units 520). Exemplary heat rejection units 530 may comprise at least one exhaust fan paired with a fan shroud, which circulate heated air up and through the at least one exhaust fan and away from consolidating units 520. For example, an exemplary heat rejection unit 530 comprises 6 exhaust fans paired with fan shrouds, exemplified in FIG. 6. In some embodiments, exemplary heat rejection units 530 may comprise heat sinks (e.g., heat sink fins) disposed on exemplary consolidating dies 500.

e. Cooling

In accordance with various embodiments, any of a variety of methods may be used to cool consolidated materials to a second temperature. In some embodiments, a second temperature is equal to or less than the glass transition temperature of at least one component (e.g., at least one thermoplastic component) of exemplary consolidated materials. For example, cooling may comprise initially cooling consolidated materials to the glass transition temperature or less than the glass transition temperature of at least one component of feed materials by at least about 5° F., at least about 10° F., by at least about 20° F., by at least about 30° F., by at least about 40° F., by at least about 50° F., by at least about 60° F., by at least about 70° F., by at least about 80° F., by at least about 90° F., by at least about 100° F., by at least about 110° F., by at least about 120° F., by at least about 130° F., by at least about 140° F., by at least about 150° F., by at least about 160° F., by at least about 170° F., by at least about 180° F., by at least about 190° F., by at least about 200° F., by at least about 210° F., by at least about 220° F., by at least about 230° F., by at least about 240° F., or by at least about 250° F.

In a non-limiting example according to various embodiments of the present disclosure, when PETg is utilized as a thermoplastic component of an exemplary feed material a second temperature may be 120° F., which is about 56° F. than the glass transition temperature of PETg.

In some embodiments, a second temperature is equal to or less than the melt transition temperature of at least one component (e.g., at least one semicrystalline thermoplastic component) of exemplary consolidated materials. For example, cooling may comprise initially cooling consolidated materials to the melt transition temperature or less than the melt transition temperature of at least one component (e.g., at least one semicrystalline thermoplastic component) of exemplary consolidated materials by at least about 5° F., at least about 10° F., by at least about 20° F., by at least about 30° F., by at least about 40° F., by at least about 50° F., by at least about 60° F., by at least about 70° F., by at least about 80° F., by at least about 90° F., by at least about 100° F., by at least about 110° F., by at least about 120° F., by at least about 130° F., by at least about 140° F., by at least about 150° F., by at least about 160° F., by at least about 170° F., by at least about 180° F., by at least about 190° F., by at least about 200° F., by at least about 210° F., by at least about 220° F., by at least about 230° F., by at least about 240° F., or by at least about 250° F.

In a non-limiting example according to various embodiments of the present disclosure, when HDPE is utilized as a thermoplastic component of an exemplary feed material a second temperature may be approximately 120° F., which is about 155° F. less than the melt transition temperature of HDPE.

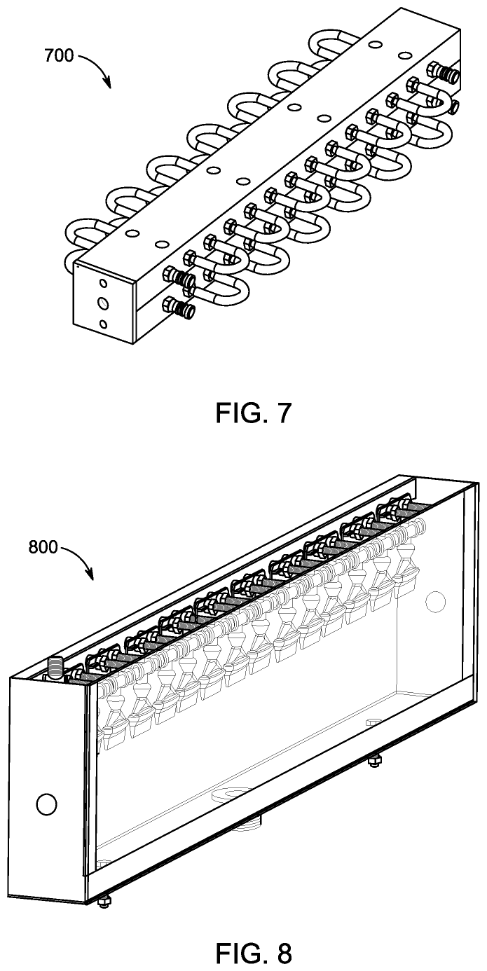

In some embodiments, initially cooling consolidated materials may be performed utilizing exemplary cooling dies 700, exemplified in FIG. 7. Exemplary cooling dies 700 operate by circulating a cooling fluid (e.g., cooling water) through the cooling dies 700 and transferring heat away from consolidated materials.

In some embodiments, cooling further comprises subsequently cooling consolidated materials to ambient temperature (e.g., room temperature). For example, subsequently cooling consolidated materials may be performed utilizing exemplary cooling units 800 for subsequently cooling consolidated materials to an ambient temperature. For example, in some embodiments an ambient temperature may be room temperature and/or a temperature which is safe to handle.

In some embodiments, exemplary cooling units 800 include flood cooling units, fan cooling units, immersion cooling units, compressed air (e.g., blown air) cooling units, sub-ambient cooling units (e.g., utilizing sub-ambient air or liquid cooling media).

Exemplary flood cooling units 800, exemplified in FIG. 8, operate by passing a stream of cooling fluid (e.g., cooling water) directly over consolidated materials. In some embodiments, exemplary flood cooling units 800 provide cooling water at a rate of at least about 0.5 gallons/min, at least about 1 gallon/min, at least about 5 gallons/min, at least about 10 gallons/min, at least about 15 gallons/min, at least about 20 gallons/min, at least about 25 gallons/min, at least about 30 gallons/min, or at least about 35 gallons/min.

f. Optional Steps and Units

In some embodiments, methods and systems of the present disclosure may further comprise optional steps and units. For example, such optional steps include injecting thermoplastic components, roll forming, surface reforming, tape/filament winding, bending/curving, conveying, and cutting, among other things.

i. Injecting Thermoplastic Components

As presented herein, injecting thermoplastic components should not be viewed in a similar context as injecting in traditional pultrusion methods and systems. In contrast to traditional pultrusion methods and systems, injecting thermoplastic components is not used to combine components of exemplary feed materials. For example, in accordance with the present disclosure, injecting thermoplastic components is not useful for saturating thermoplastic components with fiber components.

One of skill in the art will appreciate that disclosed methods and systems enable manufacturing thermoplastic products with complex geometries. Such complex geometries may lead to challenges during manufacturing, such as material voids in thermoplastic products. Accordingly, injecting thermoplastic components may enable void reduction for any of disclosed thermoplastic products. For example, void reduction may be useful for production of complex thermoplastic product geometries by filling voids at material intersections of exemplary geometries and profiles (e.g., I-beams, T-profiles, Pi-preforms, etc.). In some embodiments, injecting thermoplastic components may enable producing products having lineal surface geometries which do not require fiber components. Additionally or alternatively, injecting thermoplastic components may enable production of over-molded thermoplastic products, such as piping, tubing, among other things.

In accordance with various embodiments, any of a variety of methods may be used for injecting thermoplastic components. By way of non-limiting example, injecting thermoplastic components may be performed by screw-type thermoplastic injection systems which melt and pressurize thermoplastic components for injection. In some embodiments, injecting occurs during forming or after forming.

In some embodiments, injecting is performed by injecting thermoplastic components into exemplary forming units 500. For example, injecting thermoplastic components may include injecting thermoplastic components into exemplary consolidating units 520 to fill undesirable voids, such as voids occurring at material intersections.

In some embodiments, injecting is performed by injecting thermoplastic components into annular regions of exemplary consolidating units 520 producing products characterized as “over-molded” (e.g., pipes, pressure vessels, etc.).

In some embodiments, injecting is performed by injecting thermoplastic components into manufactured voids in exemplary consolidating units 520 to produce longitudinal features on thermoplastic product surfaces.

In some embodiments, injecting thermoplastic components to produce “over-molded” products may be performed by a mandrel or other similar device to inject thermoplastic components into the interior of a hollow profile, such as onto the inner surface of a pipe.

ii. Roll Forming

In some embodiments, disclosed methods and systems may further comprise roll forming. For example, consolidated materials are roll formed after being formed from heated feed materials. Exemplary methods and units of roll forming enable manufacturing of thermoplastic products having complex cross-sections from consolidated materials.

Any of a variety of methods and systems may be used for roll forming. By way of non-limiting example, roll forming includes passing consolidated materials through compression rollers to produce roll formed materials.

In some embodiments, roll forming may occur between initially cooling (e.g., after materials exit exemplary cooling dies 700 and before subsequently cooling (e.g., before entering flood cooling units 800).

In some embodiments, consolidated materials enter roll forming units 1500 at the glass transition temperature of thermoplastic components of feed materials, enabling overall manufacturing efficiency by utilizing energy added during manufacturing.

In some embodiments, exemplary roll forming units 1500 comprise mechanical or actuated rollers which help enable manufacturing thermoplastic products having non-lineal geometries.

In some embodiments, additional heating or cooling units may be implemented prior to or during roll forming to optimize the roll forming process. In some embodiments, heating prior to or during roll forming may be performed by infrared heating, induction heating (e.g., wherein exemplary susceptor materials are placed at areas of thermoplastic products intended to be roll formed), and/or hot air heating.

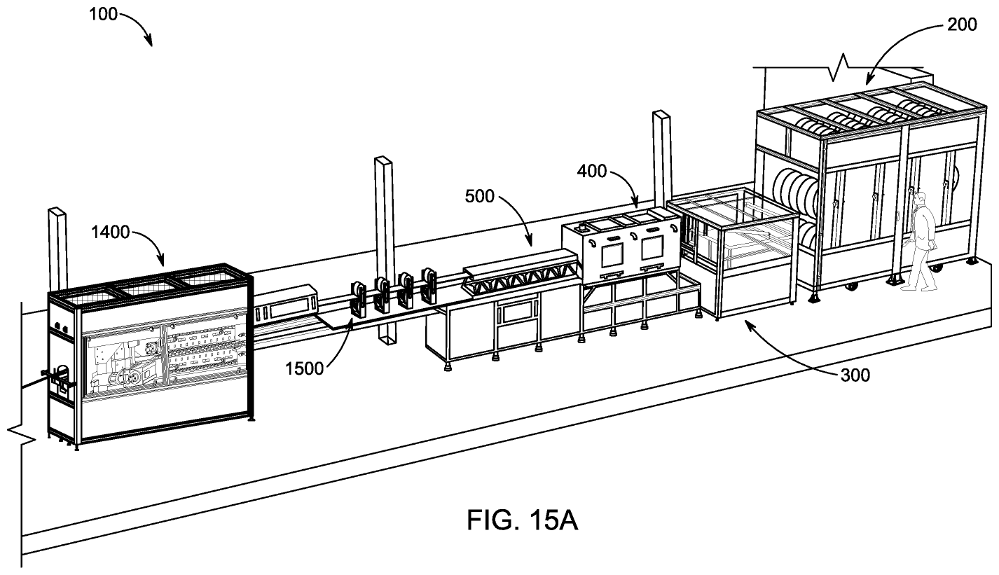

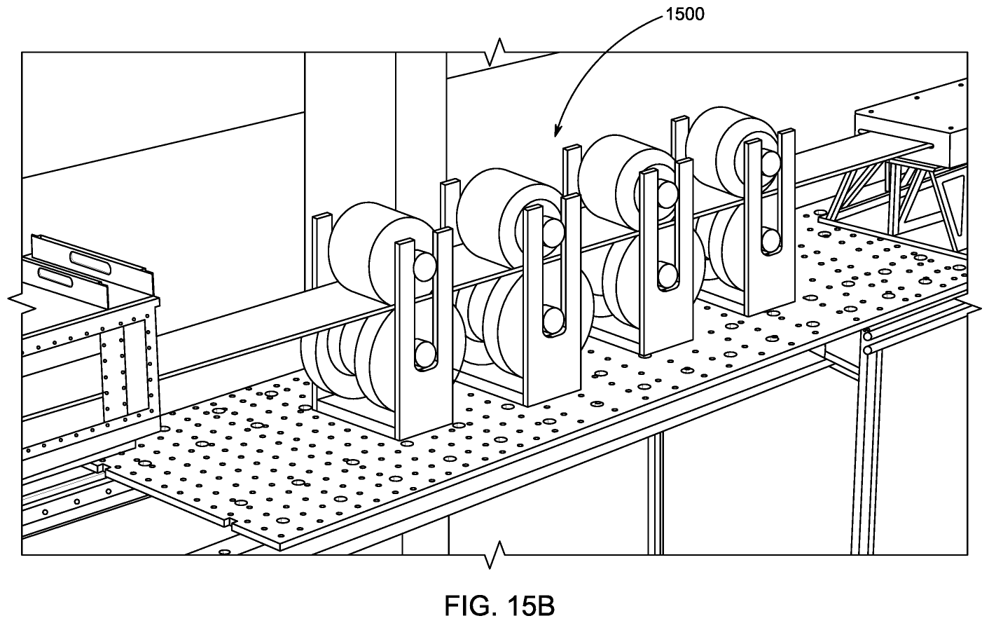

By way of non-limiting example, FIGS. 15A and 15B depict roll forming where consolidate material having an 8 inch flat plate form is being passed through an exemplary roll forming unit 1500 to produce a C-channel thermoplastic product.

iii. Surface Reforming

In some embodiments, disclosed methods and systems may further comprise surface reforming. Exemplary methods and units of surface reforming enable manufacturing of thermoplastic products having non-lineal, pattern driven surface profiles.

In accordance with various embodiments, any of a variety of methods and systems for surface reforming may be used. By way of non-limiting example, exemplary surface reforming units comprise continuous rolling molds to produce thermoplastic products having non-lineal surface profiles. For example, such profiles may comprise ridges and/or depressions on the surface of exemplary thermoplastic products.

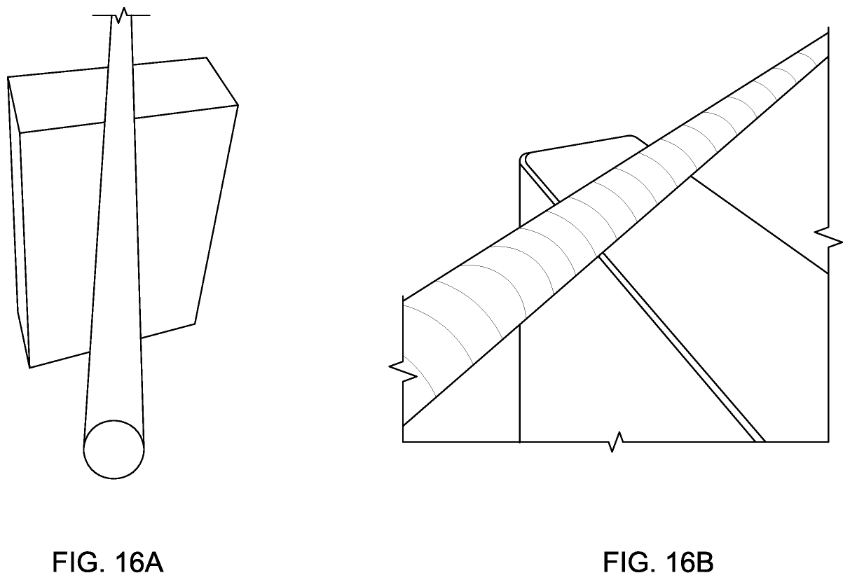

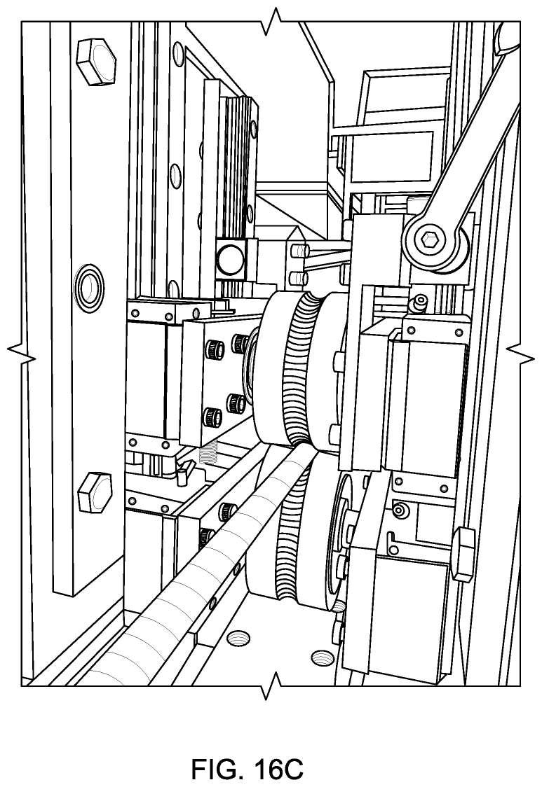

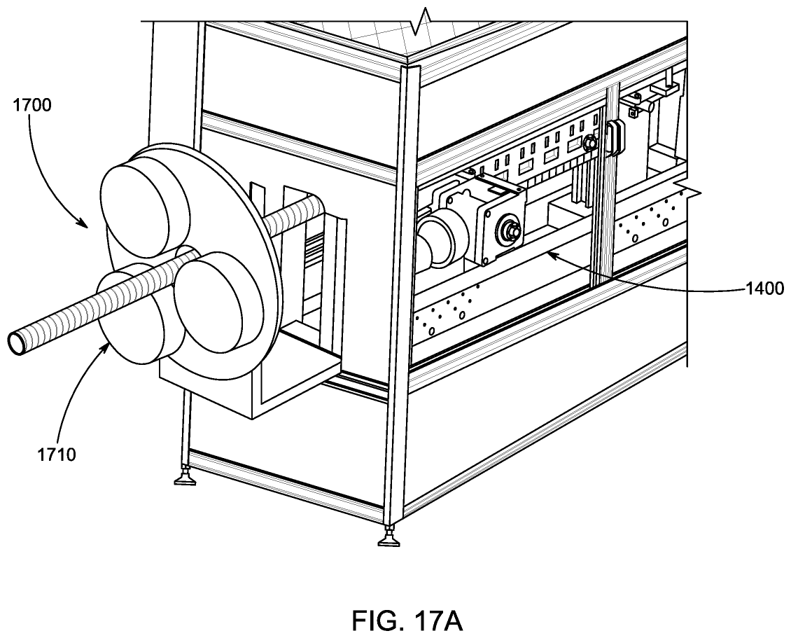

By way of non-limiting example, surface reforming includes passing consolidated materials through continuous rolling molds, exemplified in FIG. 16C, to produce surface reformed materials, exemplified in FIG. 16B, from materials having smooth lineal surface profiles, exemplified in FIG. 16A. Without wishing to be bound by any particular theory, such surface deformations may be critical for thermoplastic products in applications such as concrete reinforcing bars (e.g., rebars), where mechanical bond between the thermoplastic product and the cast concrete is essential.

In some embodiments, consolidated materials are surface reformed after being formed from heated feed materials. For example, surface reforming may occur between initially cooling (e.g., after materials exit exemplary cooling dies 700) and before subsequently cooling (e.g., before entering flood cooling units 800).

In some embodiments, exemplary surface reforming units comprise heating and/or applying pressure to enable manufacturing thermoplastic products having non-lineal surface profiles. In some embodiments, heat may be utilized from recycled thermal energy added during manufacturing. In some embodiments, heat may be utilized by in-line heating element to reheat the surface or entire cross section of materials undergoing surface reforming. In some embodiments, applying pressure occurs by rollers to produce the desired deformations. In some cases, for example wherein no further heat is applied, surface reforming takes place by locally yielding surfaces of materials.

In some embodiments, mechanical or actuated tooling enable manufacturing thermoplastic products having non-lineal surface profiles. Tooling may act upon the profile through either pressure or displacement limited methods. For example, if it is desired that deformations are applied with a given pressure, tooling may be actuated via pneumatic, hydraulic, or other pressure controlled means. If it is desired that deformations are applied with a given tool displacement, tooling may be mechanically configured with threaded or similar connections. In some embodiments, tooling methods may make use of multiple forming stages to progressively form the cross-section to the desired non-lineal surface profiles. This reduces the forces required and can limit any damage to feed materials.

In some embodiments, surface reforming comprises depositing additional material to consolidated materials. In some embodiments, additional materials may provide bulk to enhance the surface reforming, may provide different constituent properties consolidated materials, or provide a specific surface finishes to consolidated materials. By way of non-limiting example, surface reforming units may be used to apply additional material such as neat thermoplastic components, which may then be deformed more easily or may provide enhanced surface finish. In some embodiments, this may proceed by feeding continuous sheets of thermoplastic components into the region where the rolling tool contacts exemplary feed materials.

iv. Tape/Filament Winding

In some embodiments, disclosed methods and systems may further comprise tape/filament winding. Tape/filament winding enables reinforcement and/or surface modification of thermoplastic products by externally wrapping winding materials into patterns onto surfaces of thermoplastic products. For example, disclosed tape/filament winding methods may provide for surface profiling, creation of hollow pipe and rods, or tailoring of skin fiber orientation for specific applications.

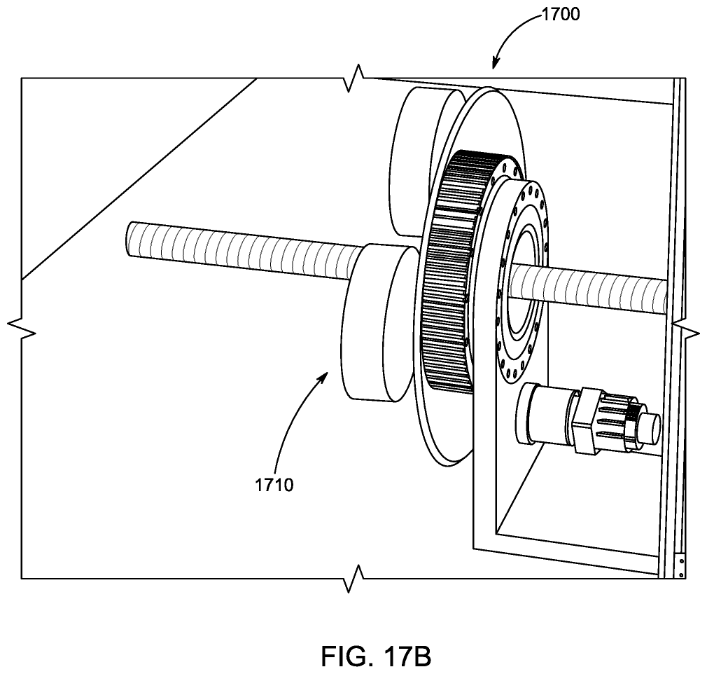

In accordance with various embodiments, any of a variety of tape/filament winding methods and systems may be used. By way of non-limiting example, an exemplary tape/filament winding unit 1700 is presented in FIG. 17A and FIG. 17B. In many embodiments, exemplary tape/filament winding units 1700 operate by rotating around non-rotating, but linearly traversing consolidated materials and depositing exemplary winding materials onto the consolidated materials.

In some embodiments, exemplary winding materials include, among other things, unidirectional (UD) tapes (e.g., for use in tape winding), bicomponent filaments (e.g., for use in filament winding). In some embodiments, exemplary winding materials may be or comprise thermoplastic components disclosed herein. In some embodiments, winding materials may be characterized as being pre-impregnated (e.g., “pre-preg”) or semi-impregnated (e.g., “semi-preg”). In some embodiments, winding materials may be or comprise functional components disclosed herein.

In some embodiments, consolidated materials undergo tape/filament winding after being formed from heated feed materials. For example, tape/filament winding may occur after cooling. Additionally, exemplary tape/filament winding units 1700 may be placed downstream of exemplary pulling units 1400.

As exemplified in FIGS. 17A and 17B, an exemplary tape/filament winding unit 1700 comprises a rotating wheel with exemplary winding materials 1710 (e.g., mounted spools of continuous fiber reinforced thermoplastic (CFRTP) tape) and winds the tape around an exemplary thermoplastic product (up to 6″ major diameter) in a specified orientation. In some embodiments, orientations will be determined based on the relationship between manufacturing rates (e.g., pulling rates) and tape/filament wrapping speed. In some embodiments, prior to tape/filament winding, exemplary winding materials are heated to improve deposition with the thermoplastic product and/or previously deposited winding material. In some embodiments, constant tension is applied to winding materials ensure consistent alignment and density of the windings.

v. Bending/Curving

In some embodiments, disclosed methods and systems may further comprise bending/curving. Bending/curving enables manufacturing thermoplastic products having bent/curved profiles, as opposed to straight, linear profiles in methods and systems which do not comprise bending/curving. For example, bending/curving may be useful for manufacturing thermoplastic products which match the curvature of a ship hull. As another example, bending/curving may be useful for manufacturing thermoplastic products which or curved into a spiral coil for use as concrete confinement and shear reinforcement.

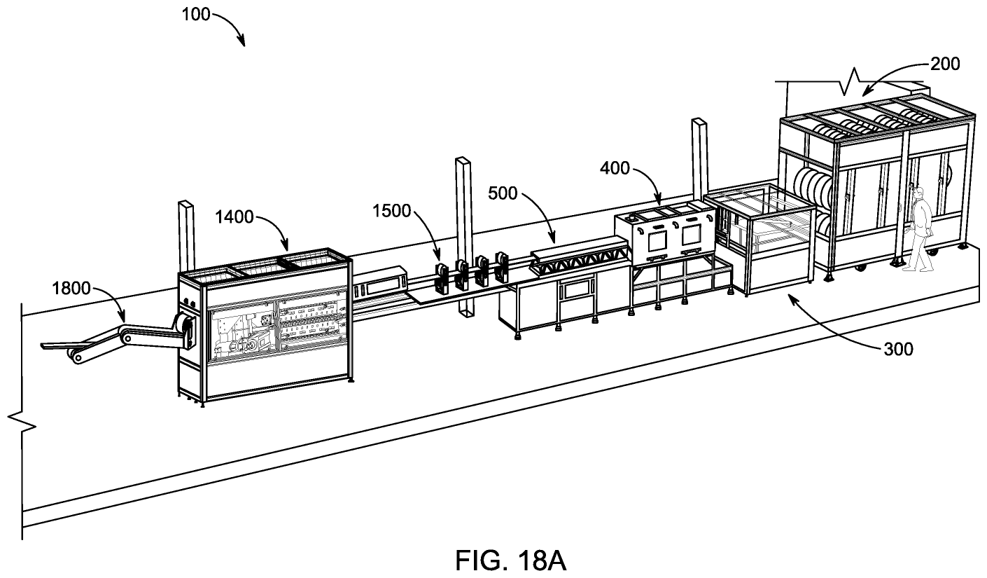

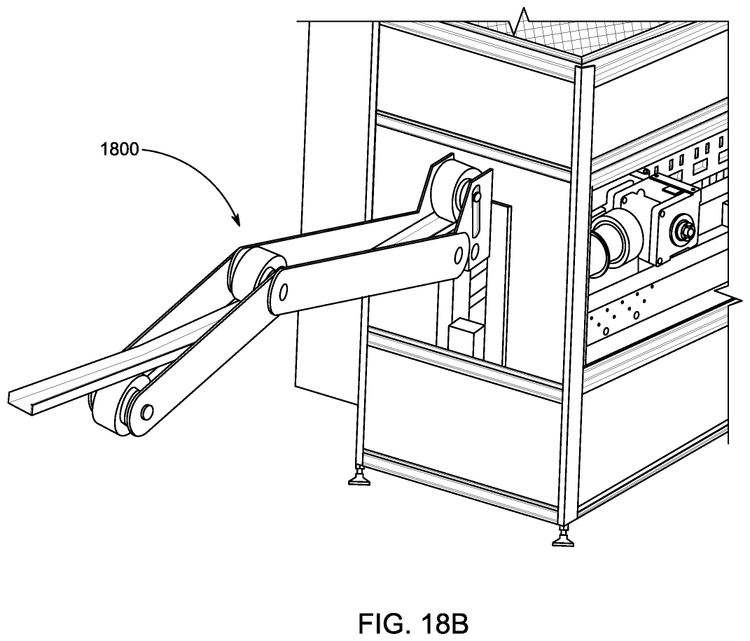

In accordance with various embodiments, any of a variety of bending/curving methods and systems may be used. By way of non-limiting example, an exemplary bending/curving unit 1800 is presented in FIGS. 18A and 18B. In many embodiments, exemplary bending/curving units 1800 are located downstream of exemplary pulling units 1400.

In some embodiments, exemplary bending/curving units comprise at least one roller to produce thermoplastic products having varying complexity of curvature (e.g., ranging from simple curved products to coiled products). In some embodiments, rollers may be powered. In some embodiments, rollers may have heating and/or cooling elements. FIGS. 18A and 18B present an exemplary bending/curving unit 1800 which is capable of producing a curved C-channel thermoplastic product by utilizing heat and offset rollers to produce a desired curvature.

In some embodiments, exemplary bending/curving units comprise robotics and/or other actuation techniques to produce thermoplastic products having varying complex of curvature (e.g., ranging from simple curved products to coiled products).

vi. Conveying

In some embodiments, manufacturing thermoplastic products further comprises conveying thermoplastic products. In accordance with various embodiments, any of a variety of methods or units may be utilized for conveying. By way of non-limiting example, a roller conveyor may be utilized for conveying. Conveying enables equilibrating the temperature of thermoplastic products before entering exemplary pulling units.

vii. Cutting

In some embodiments, manufacturing thermoplastic products further comprises cutting thermoplastic products. In accordance with various embodiments, any of a variety of methods or units may be utilized for cutting. By way of non-limiting example, an exemplary cutting unit may be utilized for cutting thermoplastic products. In some embodiments, exemplary cutting units may include automated flying saw units or automated shear units.

g. Thermoplastic Products

In accordance with various embodiments, any of a variety of thermoplastic products may be made using provided methods and systems. By way of non-limiting example, thermoplastic products are structural parts (e.g., structural members). In some embodiments, structural parts may include, among other things, reinforcing bar (e.g., rebar), plates (e.g., flat plates), I-beams, Pi preforms, structural angles, structural channels (e.g., C-channels), hollow structural sections, or pipes.

### II. Exemplary Advantages of the Disclosure

Without being bound to any particular theory, after reading the present disclosure, one of skill in the art will appreciate that disclosed methods and systems of pultrusion provide advantages over traditional pultrusion methods and systems.

a. Saturating Fiber Components

As presented herein, exemplary methods and systems utilize exemplary feed materials comprising fiber components and thermoplastic components which may be characterized as commingled. Accordingly, in many embodiments, disclosed methods and systems for manufacturing thermoplastic products from exemplary feed materials do not require saturating fiber components with thermoplastic components during manufacturing and thus do not require saturating units. As such, utilizing disclosed methods and systems provides for decreased VOC emissions and a decreased risk in environmental and/or health hazards. In contrast, traditional pultrusion methods and systems utilize feed materials comprising fiber components and thermoset components. In such systems, fiber components and thermoset components require saturating fiber components with the thermoset components during manufacturing (i.e., fiber components and thermoset components are impregnated during manufacturing.) As such, traditional methods and systems require the use of saturating units. Use of such systems and units pose, inter alia, environmental and/or health hazards due to VOC emissions. Exemplary saturating units include, inter alia, resin saturating bath units, resin injection saturating units (e.g., resin injection units which impregnate fiber components with thermoset components.)

b. Vacuuming

As presented herein, some methods and systems have attempted to overcome challenges in continuous forming to manufacture thermoplastic products, such as challenges in void reduction. However, such methods and systems rely on complex techniques, for example vacuuming, to overcome exemplary challenges. Accordingly, disclosed methods and systems do not require or comprise vacuuming methods and/or units and is therefore advantageous over known methods and systems.

### EXEMPLIFICATION

### Example 1: Manufacturing Thermoplastic Products Comprising PETg and E-Glass

A thermoplastic pultrusion machine consists of multiple distinct section. At the head of the machine, a creel unit holds the required tape reels in position and is used for storage and organization. As the tapes are drawn from the creel, they pass through a tensioning system. The tensioner removes slack from the tape lines, preventing them from sagging and coming into contact with the machine walls and with each other as they travel into the preheater.

After leaving the creel and tensioning unit, the tapes travel into the preheater, an enclosed space where they are heated by a bank of infrared process heater. It is in the preheater that the tapes will be raised to the required consolidation temperature. The tension in the tapes also provides the needed organization in this section to assist in evenly heating the tapes.

Once heated to the desired consolidation temperature, the tapes enter the collector, a wide-mouthed heated funnel designed to ease the tapes into the heated die opening. It is also at the collector that the excess material fed to the system will be sheared of. This excess matrix material, aided by the heating of the consolidating die, will be removed from the system by gravity. This will prevent the buildup of material within the system.

The consolidating die is divided into a minimum of three section. Each section tapers at a constant rate, beginning at the mouth of the first section and narrowing to the final part diameter at the outlet of the last section. The section temperatures are monitored and heated by embedded cartridge heater. Each section is separated from the others by ceramic spacers, allowing for more precise temperature control. This arrangement should accommodate most possible temperature profiles.

Similar to the ceramic spacers separating the sections of the consolidating die, a ceramic spacer will separate the consolidating die from the cooled die. After reaching the desired cross section, the material will travel into the cooled die. The material will be cooled to approximately the glass transition temperature within the cooled die, while the die simultaneously tapers outwards to facilitate ease of removal. This die section will be actively cooled by cooling water flowing through channels on the exterior of the die.

The partially cooled consolidated material exits the cooled die and passes directly into the post cooler section to finish the cooling process. The post cooler cools the core of the pultruded part, preventing any warping in the system. This is accomplished by spraying a high volume stream of cooling water onto the part.

The pultrusion process is driven by a pulling apparatus, located directly after the post cooler. In most industrial processes, the puller section consists of a pair of reciprocating hydraulically driven linear puller. Due to the scale and technical limitations of this system, a continuous track solution will be implemented instead. This type of puller is also common in industry, and while it is not capable of producing pulling forces as high as a conventional hydraulic system, it has the advantage of being easier to control. Each track of the puller will be independently driven by a motor and planetary gear se. The required compressive force between the tracks will be provided by pneumatic cylinders.

Owing to the speed at which the material will be moving through the system, an automated method of cutting off the produced thermoplastic rebar will be require. This will likely be accomplished by using a circular saw arrangement mounted on guided rail. This will allow the saw to cut the rebar as it travels with the pultrusion in order to make a straight cut

a. Major System Assumptions

A number of assumptions were made throughout the process of designing this system. Where possible, design choices were made to accommodate a range of possible value. Detailed assumptions and design considerations are included in each relevant section. Listed below are some of the major assumptions made.
1. Steady state operation: While some functions must be considered for startup and shutdown sequences, system attributes are considered for steady state operation. This includes power levels in all of the heating/cooling systems, and forces and speeds in the pulling system.
2. Constant material properties: Heat capacity, thermal conductivity and density all are functions of varying strength of temperature. They will be considered constant to simplify calculations, and an appropriate margin will be included to accommodate variances in these properties.
3. Constant die pressure of 100 psi. It is unknown what the true die pressure will be, however it is expected that it may be varied by changing operating parameters such as number of tapes fed, and pultrusion speed.
4. Negligible friction in tape movement outside of the die sections and the creel.
5. Tape fibers are arranged in a transversely isotropic manner about the pultrusion axis.
6. Negligible heat loss except for where intentionally designed or explicitly accounted for.
   b. System Properties Overview

The overall system parameters and material properties are defined in this section, and referenced in all further sections for calculations.

i. Material Properties

The material properties of the PETg-E-glass composite are critical to the design calculations contained within this document. The following information was gathered regarding known properties of the system.

TABLE 1
Exemplary Material Properties

| | |
|---|---|
| Weight fraction of glass in the tapes: | K_{glass} = 0.58 |
| Density of PETg: | ${ρ}_{PETg} = 1.29 \frac{gm}{{cm}^{3}}$ |
| Density of E-glass: | ${ρ}_{glass} = 2.55 \frac{gm}{{cm}^{3}}$ |
| Heat capacity of PETg: | $\hat{C} {p}_{PETg} = 1200 \frac{J}{kg \cdot K}$ |
| Heat capacity of E-glass: | $\hat{C} {p}_{glass} = 805 \frac{J}{kg \cdot K}$ |
| Thermal conductivity of PETg: | ${k}_{PETg} = 0.29 \frac{W}{m \cdot K}$ |
| Thermal conductivity of E-glass: | ${k}_{glass} = 1.3 \frac{W}{m \cdot K}$ |

Using the rule of mixtures for composite materials, the properties of the composite material may be calculate. From the component densities and the weight fraction of glass, the volume fraction of glass is calculated.

$${τ}_{glass} = \frac{{κ}_{glass}}{{κ}_{glass} + ( 1 - {κ}_{glass} ) \cdot \frac{{ρ}_{glass}}{{ρ}_{PETg}}} = 0.411$$

From the volume fraction of glass the composite density may be calculated.

$${ρ}_{composite} = {ρ}_{PETg} \cdot ( 1 - {τ}_{glass} ) + {ρ}_{glass} \cdot {τ}_{glass} = 1.8 \; 08 \frac{gm}{{cm}^{3}}$$

The composite heat capacity is a function of the component heat capacities, as well as the weight (mass) fraction of each in the composite. It is calculated as follows:

$$\hat{C} {p}_{composite} = \hat{C} {p}_{PETg} \cdot ( 1 - {κ}_{glass} ) + \hat{C} {p}_{glass} \cdot {κ}_{glass} = 971 \frac{J}{kg \cdot K}$$

The thermal conductivity of the composite material is critical to the behavior of the pultruded part within the heating and cooling die. The thermal conductivity is maximized along the fiber lengths, and minimized across their width. This may be described again by the rule of mixtures.

The thermal conductivity along the fiber lengths may be calculated as follows:

$${k}_{lin} = {k}_{glass} \cdot {τ}_{glass} + {k}_{PETg} \cdot ( 1 - {τ}_{glass} ) = 0.7 \; 05 \frac{W}{m \cdot K}$$

The thermal conductivity across the fiber widths may be calculated as follows.

$${k}_{trans} = {( \frac{{τ}_{glass}}{{k}_{glass}} + \frac{1 - {τ}_{glass}}{{k}_{PETg}} )}^{- 1} = 0.4 \; 26 \frac{W}{m \cdot K}$$

ii. Operating Parameters

The overall expected operating parameters of this machine are defined here and referenced in all further sections.

TABLE 2
Exemplary Operating Parameters

| | |
|---|---|
| Diameter of the produced rebar: | D = 0.5 in |
| Diameter of the consolidating die inlet: | D_{Init} = 0.55 in |
| Expected pultrusion speed: | v_{Exp} = 5 ft/min |
| Maximum pultrusion speed: | v_{Max} = 10 ft/min |

While it is not expected that this system will be further developed to produce rebar with diameters greater than ½″, the pultrusion speed may vary up to speeds as high as 10 ft/min. This consideration must be held in mind while designing all sections of the machine.

From the manufacturer's data, it is known that the tapes are 2″ across with a thickness of 0.012. This gives the cross-sectional area of the individual composite tapes as follows:

$$Cross \text{-} sectional area of each tape : {A}_{T} = 2 in \cdot 0.012 in = 0.024 {in}^{2}$$

Of use in most sections of the machine is the mass flowrate of composite. Four distinct mass flowrates must be calculated: the flowrate through the preheater, and the flowrate through the rest of the system, calculated for the expected pultrusion speed of 5 ft/min and the maximum speed of 10 ft/min. These mass flowrates will be referenced in all system calculations.

TABLE 3
Exemplary flowrates

| | |
|---|---|
| Expected preheater flowrate: | ${\dot{m}}_{ExpPre} = {A}_{T} \cdot 10 \cdot {ρ}_{composite} \cdot {v}_{Ex p} = 0.9 \; 41 \frac{lb}{min}$ |
| Expected die flowrate: | ${\dot{m}}_{ExpDie} = \frac{π}{4} {D}^{2} \cdot {ρ}_{composite} \cdot {v}_{Ex p} = 0.770 \frac{lb}{min}$ |
| Maximum preheater flowrate: | ${\dot{m}}_{MaxPre} = {A}_{T} \cdot 10 \cdot {ρ}_{composite} \cdot {v}_{M ax} = 1.881 \frac{lb}{min}$ |
| Maximum die flowrate: | ${\dot{m}}_{MaxDie} = \frac{π}{4} {D}^{2} \cdot {ρ}_{composite} \cdot {v}_{M ax} = 1.539 \frac{lb}{min}$ |

Finally, the expected temperatures in each section will be listed here for reference. These temperatures will be referenced in all system calculations.

TABLE 4
Exemplary temperatures

| | |
|---|---|
| Ambient air temperature: | T_{amb} = 60° F. |
| Exit temperature in the preheater: | Tₚᵣₑₕₑₐₜ = 350° F. |
| Maximum material temperature: | Tₘₐₓ = 400° F. |
| Assumed average operating temperature: | Tₒₚₑᵣₐₜᵢₒₙ = 350° F. |
| Exit temperature in the heated die: | T_{dieExit} = 325° F. |
| Glass transition temperature of PETg: | T_{glass} = 176° F. |
| Temperature of cooling water system: | T_{cooling} = 120° F. |

c. Creel and Tensioner
iii. Overview

The purpose of the creel system is to provide a framework on which rolls of composite tapes can be stored and uniformly distributed into the preheater. Design considerations include size of the creel, orientation of the tapes as they pass into the pultrusion system, modularity for potential design upgrades, and ease of access for replacing empty spools.

This force will contribute directly to the required pulling force in the pulling section. A separate apparatus between the creel and the preheater will be constructed to provide additional tension in the tape. This tensioner system will be comprised of two fixed cylinders and a compressed cylinder with a linear rail and spring system.

iv. Assumptions
1. System is operating at steady-state, with no change in pulling speed.
2. Constant material properties.
3. Composite tapes are free rolling.
   v. Design

It is known that the tapes being used are 2″ wide, with a thickness of 0.012. To ensure that the entirety of the die is filled, a taper is built into the heated die that allows excess material to be fed in to the system. The diameter of this tapered opening is 0.55. The number of tapes needed to fill this diameter can be calculated as such:

$$n = \frac{π {D}_{Init}^{2}}{4 {A}_{T}} = 9.90$$

To provide enough material to the system the number of tapes will be rounded up to 10 tape. The creel system will be designed to hold 16 tapes in order to account for possible design production upgrade. This will ensure that enough material is being supplied to the system to fill the die.

The secondary function of the creel section is to provide tension in the tapes in order to keep them taught as they pass through the preheater section and into the mouth of the consolidator. This tension will prevent the tapes from contacting each other, and will help to maintain the appropriate spacing needed for effective heating in the preheater. The desired tension in each tape is currently estimated to be 10 lb. Given this, and the number of tapes, the force required to unspool the tapes from the creel may be calculated.

$${F}_{tension} = 10 lb f \cdot n = 100 lb f$$

d. Preheater
vi. Overview

The preheater is responsible for raising the bulk temperature of the tapes from room temperature, to (or near to) the desired consolidation temperature. This is expected to be accomplished through the use of infrared heaters within an enclosed volume. The tapes will pass through a perforated front plate into the heating chamber. Within the preheater body the tapes will be heated by a bank of infrared heaters. The heating chamber consists of three sections to improve the efficiency of the heating system. To aid in the heating process, the interior of the body will be made of an appropriately reflective material to redirect infrared radiation back towards the tape bundle. This will help to minimize losses to the environment, and to provide an even heating pattern. A circulation fan may also be provided to aid in developing a uniform temperature throughout the tapes.

The downstream end of the preheater will be fit with a runoff drain and heater. This will allow the excess PETg fed to the system to be removed as it is sheared off by the opening of the consolidation section. The runoff heater will ensure that the material remains plastic enough to flow from the preheater and through a small opening in the underside, driven by gravity. Excess matrix material may be collected in a waste container underneath the machine.

vii. Assumptions
1. The preheater is at steady-state, with no changes in heating rate.
2. Constant material properties.
3. Infrared heating system produces even temperature profile across the tapes.
   viii. Design

The total mass flowrate of the composite through the system may be calculated as a function of the pultrusion speed, the cross-sectional area, and number of the tapes being fed, and the composite density, as done in the overall system properties section.

From the mass flowrate the required heater power may be calculate. The material enters at ambient temperatures, and exits at the preheater temperature, as defined in the system parameters section.

$${P}_{req} = m {\cdot }_{ExpPre} \cdot \hat{C} {p}_{composite} \cdot ( {T}_{preheat} - {T}_{amb} ) = 1.11 kW$$

To describe the loss of power at the heaters and from the system to the environment, two efficiencies are described below. Note that these efficiencies are estimates only, and are intended to provide a rough estimate of the power needed.

The fraction of heat provided that is used to heat the tapes: η_{transfer}=0.70

The fraction of electrical power converted to usable heat: ηₕₑₐₜₑᵣₛ=0.70

These efficiencies may be used to convert the required power to a nominal power.

$${P}_{nom} = \frac{{P}_{req}}{{η}_{transfer} \cdot {η}_{heaters}} = 2.27 kW$$

To account for the possibility of running this system at its maximum potential pultrusion speed, these calculations should be performed again using a speed of 10 ft/min.

$${P}_{req} = {\dot{m}}_{Ma xPre} \cdot \hat{C} {p}_{composite} \cdot ( {T}_{preheat} - {T}_{amb} ) = 2.23 kW$$

$${P}_{nom} = \frac{{P}_{req}}{{η}_{transfer} \cdot {η}_{heaters}} = 4.54 kW$$

Note that in the preheater it is unknown if the tape configuration will notably impact the performance of the infrared heating process. Although the preheater is insulated, there will be some heat loss to the surrounding. The efficiency η_{transfer} approximates the heat lost to the surroundings.

e. Collector and Consolidating Die
ix. Overview

Located at the end of the preheater body, the collecting funnel assists in channeling the tape bundle into the heated die. The collector funnel transitions directly to the heated die section, which tapers slowly to the final material diameter.

The consolidating die is comprised of three separate 1 ft split cavity aluminum die sections, each with a constant taper to improve consolidation. The die sections will be separated by thin ceramic spacers to allow for finer temperature control between each section, and will be heated by embedded cartridge heaters.

The role of the collector and consolidating die sections are to provide adequate consolidation pressure, finish heating the matrix to its peak required temperature, and then to begin cooling the material to a lower temperature, likely in the range of 300-325°. Pressure should be maintained over the length of the consolidating die. The consolidator funnel is also responsible for shearing off any excess matrix material, bringing the cross section towards the required size.

x. Assumptions
1. The material is assumed to always be in contact with the interior of the die.
2. The viscous flow in the matrix is negligible as it is pulled long by the fibers.
3. System is operating at steady-state, with no change in heating rate.
4. Constant material properties.
   xi. Design

The material will enter the consolidator at the preheater exit temperature, and will exit at the maximum material temperature, as defined in the overview section. The total mass flowrate of the composite through the system may be calculated as a function of the pultrusion speed, the cross-sectional area of the composite rebar, and the composite density. This is also defined in the overview section.

The total energy needed to heat the composite from Tₚᵣₑₕₑₐₜ to Tₘₐₓ can be calculated through a conservation of energy equation, assuming an insulated system. The energy needed to heat the material is based off the specific heat of the composite from the overall material properties section.

To accommodate potential inaccuracies in material properties, changes in the mass flow rate and variations in other properties, the heaters will be rated for a wide power range, up to the power required for the maximum pultrusion speed.

$${P}_{E xp} = {\dot{m}}_{ExpDie} \cdot \hat{C} {p}_{composite} \cdot ( {T}_{m ax} - {T}_{preheat} ) = 156.9 W$$

$${P}_{M ax} = {\dot{m}}_{Ma xDie} \cdot \hat{C} {p}_{composite} \cdot ( {T}_{ma x} - {T}_{preheat} ) = 313.8 W$$

The power determined in the previous equations determine the heater rating required to raise the material temperature after the die has reached its operating temperature. This does not account for the energy required to heat the dies to the required temperature within a timely fashion at startup. The energy required to heat the aluminum alloy die material from room temperature to working temperature is determined by applying the specific heat equation under ideal conditions and no heat lost. The dies will be heated from ambient, to the operating temperature as defined in the overview section.

The approximate die mass was calculated using a Solidworks mass evaluation for a 3″×3″×3′ aluminum die with a 0.5″diameter hole through the length.

$${m}_{die} = 13.48 kg$$

Approximate heat capacity of aluminum alloy:

$$\hat{C} {p}_{Al} = 904 \frac{J}{kg \cdot K}$$

The total energy requirement to raise the die to operating temperature may now be calculate. In addition, a rough timeframe of 30 minutes may be applied as a baseline startup time.

$${Q}_{die} = {m}_{die} \cdot \hat{C} {p}_{Al} \cdot ( {T}_{operation} - {T}_{amb} ) = 2302 kJ$$

$$\frac{{Q}_{die}}{30 min} = 1.3 kW$$

This gives an estimate for the power required to heat the die to the working temperature. From this power the final heater specifications may be determined.

To begin cooling the material in the heated die sections towards 300-325° F., the die sections will be covered by a heat rejection system in which cooling fans and shrouds will direct the airflow up and away from the die system. Simulations of the pultrusion process in the die sections suggest that natural convection alone may be sufficient to lower temperatures to the range of 325° F., but in the case that the die system reaches over the expected operating temperature, the cooling fan system will be implemented. For specific information on the power levels and temperatures in the heated die sections, see the “Simulations” section of this report below.

f. Heat Rejection System: Consolidating Die

The heat rejection system will be equipped with six exhaust fans paired with fan shrouds which will enclose the die. This system will force the heated air up and through the exhaust fans away from the system.

This system was designed to have a 30-minute reaction time, like that of the baseline startup time. The heat rejection system uses a combination of forced and free convection; therefore, heat transfer coefficients were calculated for each case in order to determine the total heat transfer coefficient of the system. The forced heat transfer coefficient is a product of the relationship between the Nusselt number for laminar flow, the thermal conductivity of the dies, and the characteristic length of the die. These values are listed below:

TABLE 5
Exemplary values

| | |
|---|---|
| Nusselt Number for laminar flow | N_{Nu} = 46.9 |
| around block bodies: | |
| Thermal conductivity of the dies: | ${k}_{dies} = 0.0 \; 32 \frac{W}{m \cdot k}$ |
| Characteristic length of the dies: | L = 2.4 in |

Using the above values, the forced convection heat transfer coefficient was calculated.

$${h}_{forced} = \frac{{N}_{Nu} \cdot {k}_{dies}}{L} = 24.6 \frac{W}{{m}^{2} \cdot K}$$

The free convection heat transfer coefficient was calculated using the equation below.

$${h}_{free} = \frac{{k}_{dies} \cdot {10}^{1.2}}{L} = 8.3 \frac{W}{{m}^{2} \cdot K}$$

This relationship was defined using the correlation curve for free convection between various shapes and fluid. (From “The Basic Laws and Data of Heat Transmission III —Free Convection” by W. J. King.)

By using these heat transfer coefficients, the total heat transfer rate can be calculated.

$$Q = {h}_{total} \cdot A \cdot Δ T = 357 W$$

This yields a cooling time of 30.9 minute.

$$t = \frac{m \cdot {C}_{p} \cdot Δ T}{Q} = 30.9 minutes$$

g. Cooling Die Section
xii. Overview

The role of the cooling die is to lower the temperature of the heated composite material down to the glass transition temperature for the matrix. Once the material has reached the glass transition temperature it may be drawn from the cooled die without risk of deforming due to uneven cooling rate. The glass transition temperature is listed in the overall material properties section.

As the composite cools the matrix will become stiffer, losing its ability to flow as a viscous plastic. Additionally the material itself will contract as it cools as a function of the coefficients of thermal expansion for the matrix and fiber. Both of these factors will decrease the efficiency of heat transfer from the material to the cooling die. Owing to the difficulty in predicting the impact of these variations on the overall heat transfer, it will be assumed that the process is idea. More information regarding this assumption is available in the Thermal Simulation section of this report.

xiii. Assumptions
1. The material is assumed to always be in contact with the interior of the die.
2. The viscous flow in the matrix is negligible as it is pulled along by the fibers.
3. System is operating at steady-state, with no change in cooling rate.
4. Constant material properties.
5. Resistance to heat transfer from the die to the cooling water is negligible.
   xiv. Design

The mass flowrate through the cooling die is given by the die flowrates in the overview section for the expected and maximum pultrusion rate. The cooling die will take in material at the die exit temperature, and will lower the bulk temperature to the glass transition temperature, as also defined in the overview section. Using these flowrates, the heat capacity of the composite and the expected cooling difference in the die, the total rate of heat removal may be calculated.

$${P}_{Ex p} = \hat{C} {p}_{composite} \cdot {\dot{m}}_{ExpDie} \cdot ( {T}_{glass} - {T}_{dieExit} ) = - 4 \; 61.3 W$$

$${P}_{m ax} = \hat{C} {p}_{composite} \cdot {\dot{m}}_{MaxDie} \cdot ( {T}_{glass} - {T}_{dieExit} ) = - 9 \; 22.6 W$$

It is important to note the assumptions made in determining these power level. The assumption that the composite has adequate contact with the die surface is most likely the least certain assumption, as described above. The assumption that viscous flow in the matrix is negligible carries the implicit assumption that the heat generated by viscous losses is also negligible.

h. Post Cooler Section
xv. Overview

The role of the post cooler is to further cool the composite rebar from glass transition temperature down to around room temperature. Due to the growing inefficiency of cooling the material with a solid die surface as it cools (as described in the cooled die section) the post cooler operates by passing a stream of cooling water directly over the part as it is pultruded.

xvi. Assumptions
1. Constant wetted area.
2. System is operating at steady-state, with no change in cooling rate.
3. Constant material properties.
4. Bulk rebar temperature is lowered to just above the temperature of the cooling water.
5. Rebar skin temperature is at the cooling water temperature everywhere.
6. Cooling water temperature rise is negligible.
   xvii. Design

The post cooler will lower the bulk temperature of the composite from the glass transition temperature to roughly the temperature of the cooling water. As with most problems in fluid dynamics, the solution process relies on a number of assumption. The calculated values for heat transfer in this section will be estimates only. The equation below can be used to calculate the required power delivery from the rebar to the cooling water for both the expected pultrusion rate and the maximum pultrusion rate.

$${P}_{E xp} = {\dot{m}}_{ExpDie} \cdot \hat{C} {p}_{composite} \cdot ( {T}_{cooling} - {T}_{glass} ) = - 1 \; 75.7 W$$

$${P}_{M ax} = {\dot{m}}_{M axDie} \cdot \hat{C} {p}_{composite} \cdot ( {T}_{cooling} - {T}_{glass} ) = - 3 \; 51.5 W$$

The potential rate of heat removal may be found by using this equation:

$${P}_{calc} = A \cdot h \cdot Δ {T}_{l n}$$

Where A_{T} is the total surface area of the rebar exposed to the water, h is the calculated heat transfer coefficient, and ΔTₗₙ is the log-mean temperature difference.

A_{T} may be found using the surface area of a cylinder:

$${A}_{T} = π D L = 56.5 \; 49 {in}^{2}$$

Where D is the diameter of the rebar and L is the length of the rebar that will be within the post cooler, approximately 1 ft.

The calculated heat transfer coefficient was found using the equation below:

$$h = N {u}_{w} \cdot \frac{{k}_{w}}{D}$$

Nu_{w} is the approximate Nusselt number for the water over the rebar. To calculate the Nusselt number, the Reynolds and Prandtl dimensionless numbers for the cooling water must first be determined, with the characteristic length as the diameter of the rebar. The relevant values for these dimensionless groups are listed below. Note that all material properties for water were evaluated at the assumed cooling temperature of 120° F.

| | |
|---|---|
| Density of water: | ${ρ}_{w} = 989 \frac{kg}{{m}^{3}}$ |
| Dynamic viscosity of water: | μ_{w} = 0.5579 cP |
| Thermal conductivity of water: | ${k}_{w} = 0.6 \; 394 \frac{W}{m \cdot K}$ |
| Heat capacity of water: | $\hat{C} {p}_{w} = 4.18 \frac{J}{gm \cdot K}$ |
| Estimated fluid velocity: | ${v}_{w} = 1 \frac{m}{s}$ |

From the above data, the required dimensionless groups may be calculated.

$$R {e}_{w} = \frac{D \cdot {v}_{w} \cdot {ρ}_{w}}{{μ}_{w}} = 2.251 \cdot {10}^{4}$$

$$P {r}_{w} = \frac{\hat{C} {p}_{w} \cdot {μ}_{w}}{{k}_{w}} = 3.652$$

For these conditions and the geometric condition of a submerged cylinder with its axis perpendicular to the flow direction, a Nusselt number correlation may be constructed. Note that this correlation is based on empirical data for geometrically similar systems, and will yield an estimate for the Nusselt number.

$$N {u}_{w} = 0 .193 \cdot {Re}_{w}^{0.618} \cdot {Pr}_{w}^{\frac{1}{3}} = 14 \; 5.5$$

Given this estimated Nusselt number, the overall heat transfer coefficient between the cooling water and the rebar may now be calculated.

$$h = N {u}_{w} \cdot \frac{{k}_{w}}{D} = 7.3 \; 26 \frac{kW}{{m}^{2} \cdot K}$$

The remaining required piece of information is the log-mean temperature difference between the cooling water and the rebar. The calculation of this value rests on assumptions 4 and 5 for this section: that the bulk rebar temperature is lowered to just above the temperature of the cooling water, and that the rebar skin is at the cooling water temperature everywhere in the post cooler section. It will be assumed that the bulk rebar temperature falls to within 1° F. of the cooling water temperature.

$$Δ {T}_{l n} = \frac{( {T}_{glass} - {T}_{c o o l i n g} ) - ( 1 Δ° F . )}{ln ( \frac{{T}_{glass} - {T}_{cooling}}{1 Δ° F .} )} = 13.9 ° F .$$

Finally, the estimated rate of heat transfer for these conditions may be calculated.

$${P}_{calc} = {A}_{T} \cdot h \cdot Δ {T}_{l n} = 70 , 320 W$$

This calculated power value far exceeds even the maximum required rate of heat removal in the post cooler section. This indicates that the bulk temperature of the rebar will likely be lowered even closer to the temperature of the cooling water.

The validity of assumption 6 may now be confirmed. This is accomplished by applying an energy balance over the cooling water stream. The physical properties of water listed above will be used in this determination. The mass flowrate of water will be based off an assumed volumetric flowrate of 4 GPM in the post cooler section.

$$\begin{matrix}{\dot{m}}_{w} = 4 GPM \cdot {ρ}_{w} = 0.25 \frac{k g}{s} \\ Δ {T}_{w} = \frac{\vert {P}_{Max} \vert}{\hat{C} {p}_{w} \cdot {\dot{m}}_{w}} = 0.54 Δ° F .\end{matrix}$$

With a maximum temperature rise of just over ½° F., assumption 6 appears to be validate. Again, these calculations are not to be taken as precise calculations of the expected operating condition. Rather, they should be interpreted as providing confirmation that the system as proposed will function as intended. The high capacity for heat transfer at the rebar-fluid interface is illustrated by the calculated cooling power which far exceeds what is require. This should ensure that even with non-ideal conditions, the system should be capable of removing the necessary heat to cool the rebar adequately.

i. Heat Rejection System: Post Cooler System
xviii. Overview

To save on costs and reduce system complexity, the cooled die and post-cooler sections will share one cooling fluid system. This system will be responsible for circulating cooling water, and rejecting heat to the air for both sections.

The heat rejection system will draw fluid from a reservoir, pumping it in parallel to the post-cooler and the cooled die. The stream passing through the post-cooler will return directly to the reservoir after flowing over the pultrusion. The stream passing through the cooled die channels will first pass through a radiator before returning to the reservoir.

xix. Assumptions
1. System is operating at steady-state, with no change in cooling rate.
2. Heat transfer coefficient between cooling water and radiator far exceeds the heat transfer coefficient between the air and radiator.
3. Hydraulically smooth piping.
   xx. Flow Design

The coolant pump may be specified by the required flowrate and the head loss of the system. The piping used is assumed to be hydraulically smooth, permitting the use of the Blasius equation in computing the friction factors for fluid flow. Two inline valves will be used to control the fluid flow to each branch, allowing the system to be defined by desired flowrate. These flowrates, as well as estimates for piping parameters and properties of water are listed below.

TABLE 6
Exemplary flowrates, piping parameters and properties of water

| | |
|---|---|
| Flowrate in the radiator and cooling die: | V_{Die} = 2 GPM |
| Flowrate in the post cooler: | V_{Post} = 4 GPM |
| Total flowrate through the pump: | V_{Total} = 6 GPM |
| Inside diameter of the piping: | Dₚᵢₚₑ = 0.622 in |
| Inside diameter of the radiator tubing: | D_{Rad} = 0.375 in |
| Inside diameter of the cooling die channels: | D_{Die} = 0.25 in |
| Approximate total length of piping: | Lₚᵢₚₑ = 5 ft |
| Approximate length of radiator tubing: | L_{Rad} = 30 ft |
| Approximate length of die channels: | L_{Die} = 10.5 ft |
| Density of water: | ${ρ}_{w} = 989 \frac{kg}{{m}^{3}}$ |
| Viscosity of water: | μ_{w} = 0.5579 cP |

To calculate the Reynolds numbers, the bulk fluid velocity must be first calculated for each section.

$$\begin{matrix}{v}_{P i p e} = \frac{4 \cdot {V}_{T o t a l}}{π \cdot {D}_{Pipe}^{2}} = 6.34 \frac{f t}{s} \\ {v}_{R a d} = \frac{4 \cdot {V}_{D i e}}{π \cdot {D}_{R a d}^{2}} = 5.81 \frac{f t}{s} \\ {v}_{D i e} = \frac{2 \cdot {V}_{D i e}}{π \cdot {D}_{D i e}^{2}} = 6.54 \frac{f t}{s}\end{matrix}$$

Now armed with the fluid velocities, the Reynolds number for each section may be calculated.

$$\begin{matrix}R {e}_{P i p e} = \frac{{D}_{Pipe} \cdot {v}_{Pipe} \cdot {ρ}_{w}}{{μ}_{w}} = 5 \text{.41} \cdot {10}^{4} \\ R {e}_{R a d} = \frac{{D}_{R a d} \cdot {v}_{R a d} \cdot {ρ}_{w}}{{μ}_{w}} = 2 \text{.99} \cdot {10}^{4} \\ R {e}_{D i e} = \frac{{D}_{D i e} \cdot {v}_{D i e} \cdot {ρ}_{w}}{{μ}_{w}} = 2 \text{.24} \cdot {10}^{4}\end{matrix}$$

Using the Blasius equation, the corresponding friction factors for each section may be determined.

$$\begin{matrix}{f}_{P i p e} = \frac{0.079}{R {e}_{Pipe}^{025}} = 5.2 \cdot {10}^{- 3} \\ {f}_{R a d} = \frac{0.079}{R {e}_{R a d}^{0.25}} = 6. \cdot {10}^{- 3} \\ {f}_{D i e} = \frac{0.079}{R {e}_{D i e}^{0.25}} = 6.5 \cdot {10}^{- 3}\end{matrix}$$

Finally, given the flowrates and friction factors for each section, the overall pressure loss may be calculated and summed across the system.

$$\begin{matrix}Δ {P}_{P i p e} = 2 \cdot {f}_{P i p e} \cdot \frac{{L}_{Pipe}}{{D}_{Pipe}} \cdot {ρ}_{w} \cdot {v}_{P i p e}^{2} = 0.5 \; 35 psi \\ Δ {P}_{R a d} = 2 \cdot {f}_{R a d} \cdot \frac{{L}_{R a d}}{{D}_{R a d}} \cdot {ρ}_{w} \cdot {v}_{R a d}^{2} = 5.19 psi \\ Δ {P}_{D i e} = 2 \cdot {f}_{D i e} \cdot \frac{{L}_{Die}}{{D}_{Die}} \cdot {ρ}_{w} \cdot {v}_{D i e}^{2} = 3.7 psi \\ Δ {P}_{T o t a l} = Δ {P}_{P i p e} + Δ {P}_{R a d} + Δ {P}_{D i e} = 9.43 psi\end{matrix}$$

This pressure loss may be converted into a head loss to aid in determining pump specifications.

$$Δ H = \frac{Δ {P}_{T o t a l}}{{ρ}_{w} \cdot 32.2 ft / {s}^{2}} = 22. ft$$

xxi. Thermal Design

The selected radiator must be capable of rejecting the combined heat of the cooling die and post cooler. To accommodate for the potential that the cooling die will accept hotter material, the power will be rated on the basis of lowering the material temperature from the system maximum, down to the assumed temperature of the cooling water. This combined power rating may be calculated as follows:

$${P}_{reject} = {\dot{m}}_{E x p D i e} \cdot \hat{C} {p}_{c o m p o s i t e} \cdot ( {T}_{max} - {T}_{c o o l i n g} ) = 878 W$$

$${P}_{rejectMax} = {\dot{m}}_{M a x D i e} \cdot \hat{C} {p}_{c o m p o s i t e} \cdot ( {T}_{max} - {T}_{c o o l i n g} ) = 1757 W$$

The selected radiator must be able to accommodate these cooling requirements at a flowrate of 2 GPM. As of now, the selected radiator (whose tubing properties are listed in the flow design portion of this section) is rated to handle these power levels.

j. Thermal Simulations

The majority of thermal considerations in the consolidating and cooling die sections were handled using a simulation of the system using COMSOL Multiphysics. It is important to note that the thermal simulations in this section do not include the heat rejection system for the consolidating die. This is because the die system is designed to operate without a heat rejection system.

xxii. Materials

The composite material was represented using a plastic plug-flow mode. This was accomplished by permitting slip at the mold boundaries, and assigning a high shear strength to the material. This allowed for the uniform velocity profile in the die to be simulate. The remaining material properties were assigned using the values calculated above.

The composite fluid domain was assigned the custom composite material. The cooling water fluid domains were assigned a generic water material. The dies were assigned an aluminum material, and the ceramic spacers were assigned a ‘brick’ material, chosen for its high thermal resistance, similar to that of the proposed ceramic spacers.

xxiii. Geometry

A Solidworks model of the dies and the fluid domains was created and imported into COMSOL. This included the three heated die sections and their corresponding ceramic spacers, the cooling die with fluid channels, and cooling die channel cover plate. Solid bodies were also created for the composite domain and the cooling fluid domains, which aided in defining the fluid domains in COMSOL. The heated and cooling dies included their appropriate bolt holes, as well as holes in the heated die for cartridge heaters.

xxiv. Boundary Conditions

Boundary conditions were specified using parameters similar to what is expected for the final machine.

xxv. Composite Boundaries

At the inlet of the system, the cross-section of the composite was assigned two boundary conditions:
1. Inlet velocity, set to be 5 ft/min
2. Inlet temperature, set to be the expected exit temperature of the preheater, 350° F.

Along the length of the die the boundary condition was set to allow fluid slip, a feature which allowed the plug-flow that is expected.

At the outlet of the system, the cross-section of the composite was assigned two boundary conditions:
1. Outlet velocity, normal flow to disregard edge effects
2. Outlet thermal condition to permit heat flow out of the system
   xxvi. Cooling Water Boundaries

The cooling water domains made use of a set of boundary conditions similar to those for the composite material. At the inlets, the cross-section of the water flow was assigned two boundary conditions:
1. Inlet velocity, set to be the rate required to allow a 2 GPM flowrate
2. Inlet temperature, set to be an estimated 110° F.

Unlike the composite material, the water was given a no-slip condition with the walls of the cooling die. This more accurately models the flow in the cooling channels.

At the outlets, the cross-section of the water was given two boundary conditions:
1. Outlet velocity, normal flow to disregard edge effects
2. Outlet thermal condition to permit heat flow out of the system
   xxvii. Solid Boundary Conditions

The following boundary conditions were applied to the solid objects of the die.

Heated die sections:
1. Thermal insulation on the undersides to represent the ceramic mounting solution
2. Natural convection on the exposed sides and to. This is to allow more fine control over the composite temperature as it travels through the system
3. Heat flux through the surfaces of the cartridge heater mounting hole. The net power for each section was set independently. The power in each section is low to allow the material to begin cooling slowly towards 325° F.
a. Section 1: 125W total
b. Section 2: 40W total
c. Section 3: 5W total

Cooled die:
1. Thermal insulation on the underside to represent the ceramic mounting solution
2. Natural convection on the exposed sides and to. The cooling die will not be insulated since any heat lost to the surroundings in this section aids the cooling process.
   xxviii. Meshing

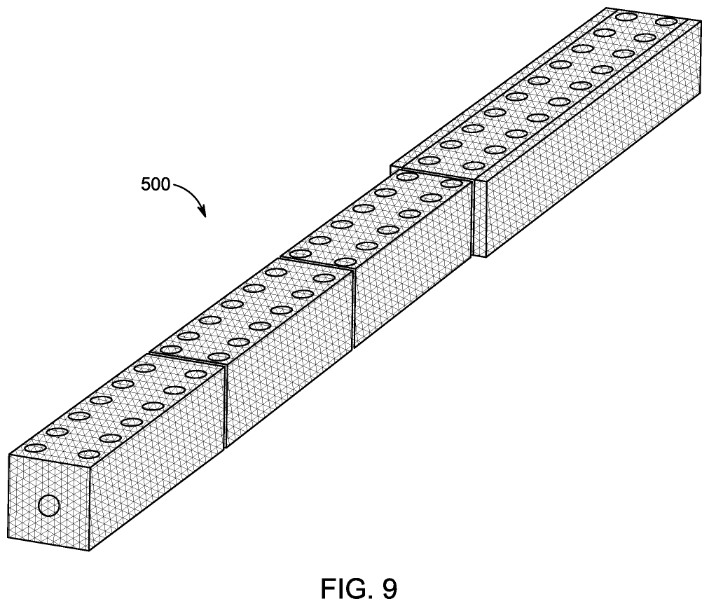

A user-defined mesh was implemented for this mode. Special attention was paid to the boundary mesh elements for the fluid domains, as well as for the faces cooled by natural convection. A mesh of 1.986 million elements was use. Solutions showed good convergence over different meshing condition. An exemplary die meshing is presented in FIG. 9.

xxix. Results

Given the above conditions, the simulation yielded encouraging dat. Temperature distributions were roughly what was expected. The composite entered at 350° F. where it remained for the majority of the first die section. Between the second and third die sections the material began cooling due to the natural convection at the die outer surfaces, falling to roughly 340° F. in the second and 325° F. in the third die. The ceramic spacers between the four die sections proved effective in preserving temperature control in each zone.

At the transition to the cooling die, the material quickly cooled rapidly towards the cooling water temperature, reaching a core temperature of approximately 113° F. before exiting the system. In reality the effectivity of this cooling section will likely be lower as the material cools and loses firm contact with the die wall. This will likely not pose a substantial problem, so long as the material is still cooled to roughly the glass transition temperature before exiting into the post-cooling solution. If higher rates of heat removal are required throughout the die system, the heat rejection system for the consolidating dies will be implemented.

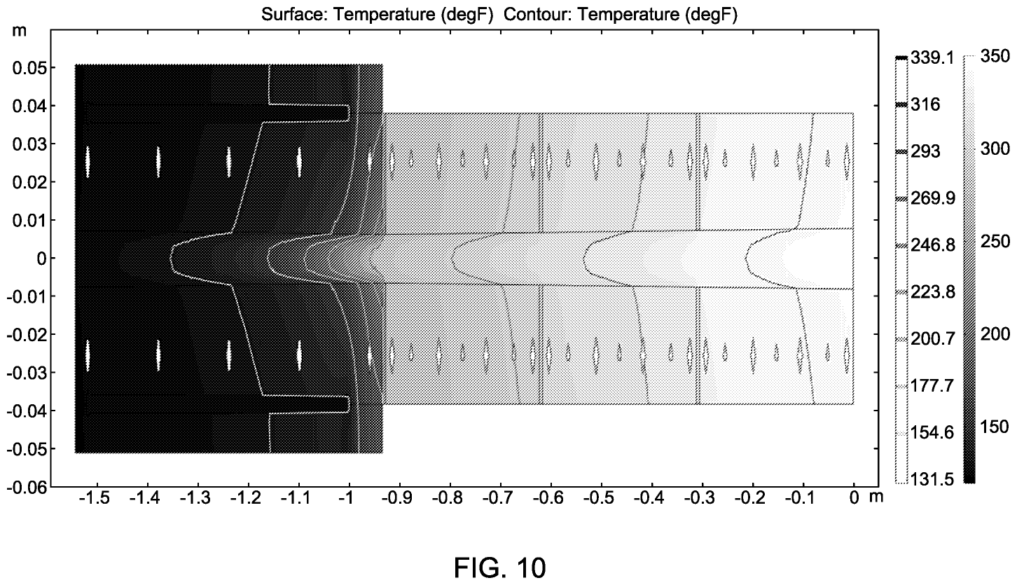

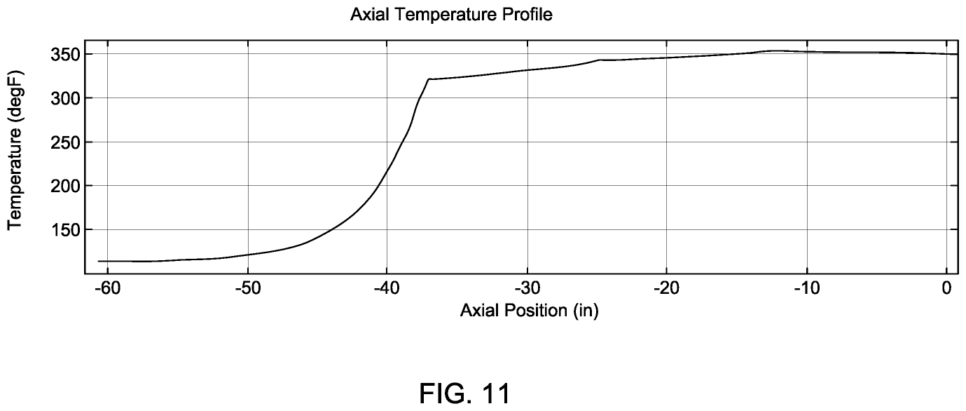

There are a number of interesting features to note in the generated simulation dat. The rapid rate of cooling at the cooling die transition may be reduced by moving the cooling channels further from the upstream die end. The heated dies are also able to be maintained near the desired temperatures with minimal heat input as only the convective heat loss is being combatted. Exemplary die temperature profiles are presented in FIG. 10 and FIG. 11.

k. Conveyor Section

If needed, the purchase of a roller conveyor will be made from McMaster-Car. The potential role of the conveyor section is to allow the temperature within the rebar to equalize through its width before it enters the puller.

l. Puller Section

All of the pulling force require to move the composite from the creel, through the dies, and into the cut-off section is generated by the puller. Typical industrial solutions for pultrusion pullers fall into two major categories:

Dual reciprocating hydraulic puller. These systems consist of two independent hydraulic grippers that pinch the part and pull it forward using a hydraulic ram, moving in alternating directions so that one is always pulling the part at all times.

### Exemplary Advantages of Using Hydraulic Pullers

1. Few moving parts compared to other solutions.
2. High pulling forces due to the use of a hydraulic system.

### Disadvantages of Using Hydraulic Pullers

1. Greater technical requirements, both for the hydraulic power needed and the controls to drive the system.
2. Greater space requirements for hydraulic cylinders and controls.

Opposing track puller. These systems are comprised of two opposing tracks fitted with an appropriate gripping material. One track is allowed to move vertically and the tracks pinch the part, pulling it through the dies as the tracks rotate. An exemplary track puller is shown in FIGS. 13, 14A-14E.

### Advantages of Using Opposing Track Pullers

1. Possible to drive with electric motors and pneumatics, simplifying the control and power delivery methods.
2. Space requirements may be lower as the length is largely determined by the designed grip length.

### Disadvantages of Using Opposing Track Pullers

1. Greater number of moving parts compared to reciprocating pullers.
2. Difficult to drive in small systems as required motor sizes quickly grow in size for increasing torque requirements.

To keep costs as low as possible and to limit the required control considerations, the opposing track system was chosen for this machine. The approximate design will consist of two tracks, each driven independently by electric gear motor. For simplicity, while the system may accommodate two motors, only one will be fitted to star. If it is found that additional drive force is required, a second motor and gearbox will be fitted.

One track will be mounted on linear rails, allowing it to be raised and lowered by a set of pneumatic cylinder. The tracks will be fabricated from two parallel strands of roller chain each, connected by steel bars onto which the gripping material will be affixed. Variable Frequency Drive (VFD) units will allow the motors to be driven at the desired pultrusion speed.

FIG. 13 and FIGS. 14A-14E below show the current design for the puller section. FIG. 14A presents an overview of the whole section including the pneumatic cylinders responsible for compressing the carriages, the outer tubular frame, and the geared drive motor. FIG. 14B provides a side-on view of the machine, more clearly displaying the linear shafts on which the upper carriage travels, as well as the shape of the carriage frame. FIG. 14C gives a front view, showing the way in which the two tracks meet. FIG. 14D and FIG. 14E show the carriages and their internal constructions.

There are two parameters critical to the design of the puller section: the desired pulling speed, and the required pulling force. The drive speed is defined by the overall system parameters, with a maximum speed of 10 ft/min. The required pulling force is compiled from the summation of the contributions from the creel, heated and cooled die, and cut-off sections.

$$\begin{matrix}{F}_{Preq} = 1500 lbf \\ {v}_{pultrusion} = 5 ft / min \\ {v}_{max} = 10 ft / min\end{matrix}$$

The current motor and drive sprocket combination ordered for use in the puller have the following characteristics:

$$\begin{matrix}Rated speed : {ω}_{rated} = 7.7 rpm \\ Constant torque : {τ}_{C} = 11 , 300 in \cdot lbs \\ Sprocket pitch diameter : D = 6.91 in\end{matrix}$$

It is difficult to know what the coefficient of friction between the puller grips and the pultruded part will be, as little data exists to describe the coefficient of friction for the matrix. However, it may be safely assumed that the coefficient of friction will be no less than 0.25.

Coefficient of static friction: μs=0.25

The approximate drive speed may be calculated from the rated motor speed and the sprocket pitch diameter.

$${v}_{a p p} = \frac{{ω}_{r a t e d} \cdot D}{2} = 13.9 ft / min$$

Approximate boundaries for VFD speed control range from 20% to 125% of the rated motor speed. This range produces a corresponding range of possible drive speeds.

$$\begin{matrix}{v}_{min} = \frac{{ω}_{r a t e d} \cdot D \cdot 0.2}{2} = 2.79 ft / min \\ {v}_{max} = \frac{{ω}_{r a t e d} \cdot D \cdot 1.25}{2} = 17.4 ft / min\end{matrix}$$

Similarly, the available drive force from one motor may be calculated from the continuous torque and the sprocket pitch diameter.

$${F}_{puller} = \frac{2 \cdot {τ}_{C}}{D} = 3 , 270 lbs$$

When compared to the approximate required pulling force, this system would yield a design margin of nearly 2.2. This has the obvious advantages or allowing for possibly higher pulling forces, and will put a smaller load on the motor. This will decrease wear and heat within the motor and gearbox.

The required compressive force between the tracks may be calculated from the estimated coefficient of friction and the required drive force.

$${F}_{compressive} = \frac{{F}_{P r e q}}{{μ}_{S}} = 6000 lbs$$

The choice of using independent drive units comes with an important consideration. If the two drives are allowed to rotate at slightly different speeds, the resulting difference in track speeds may cause harm to the pultruded part or to the puller section itself. There are handful of solutions to this problem.

First, the problem may be avoided entirely by instead specifying a motor and gearbox that are able to provide the required torque and rotational rate with one unit, rather than two. The drawbacks to this solution are that the corresponding components of the puller must be designed to handle this higher load in one carriage, rather than two. This includes the roller chain, the drive and idler shafts, as well as the torque arm assembly. Additionally, the price for gearboxes grows rapidly and non-linearly with increased torque requirement. It may be more expensive to implement a single gearbox system rather than a dual gearbox solution.

The tracks may be made to rotate at the same rate by one of a few different possible method. First, by using encoder feedback the motor speeds may be adjusted to track each other closely. This would result in small speed discrepancies that would likely not be significant enough to impact machine performance. Second, depending on the choice of VFD units, the motors may be set to operate in a torque limited method. This would prevent one motor from exerting more force on the pultrusion than the other. Finally, a single large VFD may be chosen to drive both motors, providing identical drive signals to each motor.

It is also worth noting that the choice of grip material may also impact the severity of speed differences on the system. Softer, thicker pads could aid in compensating for small speed differences.

m. Cut-Off Section

At the expected operational speed of 5 ft/min, the produced rebar will need to be regularly cut as it is produced, with new sections being cut off approximately once a minute. This level of cutting activity is not reasonable for a worker, especially when considering the dust, fumes, and fibers generated by cutting composite material. Instead, the material will be cut by an automated system, forming the cut-off section.

As the pultruded part leaves the puller it will move directly into the cut-off section. At this time, it is expected that a machine already at the ASCC will handle this task. The initial deployment of this pultrusion line will likely lack this cutoff machine, which will be added later when space requirements and machine performance are better known.

Exact parameters regarding required forces and cutting speeds are currently unknown. The system will likely follow best practices for cutting composites in terms of cutting speed, blades, and forces.

n. Frame Section

The frame is the supportive structure holding the preheater, consolidation, and cooling die. It is designed to brace against the pullers structure, transferring any forces from the puller into compression of the structure.

Do to the uncertainty in the final design, the design of the frame will be based off of the following requirements:

### Requirements:

Resist forces from the puller transmitted as a reaction force from the friction will form a maximum case equal the total force of the puller.

The frame will resist the maximum force from the puller as a moment, and as compression. The moment is caused by the offset between the pultrusion line at the center point of the die and the highest point along the face of the frame in contact to the puller system. The compressive force is caused by the pulling force and is parallel to i. This force is resisted by the contact of the frame face, with the face of the puller system.

The frame design will resist the moment by the counter moment form the weight of the system. The Compression force will be resisted by the material properties of the construction material and the contact area the force is transferred.

The frame design will also require paneling and doors for ease of access and storage throughout the machine.

o. Controls Section

With the notable number of conditions that must be monitored in the operation of this machine, and the corresponding operating parameters to adjust, a robust controls system is require. This system must be capable of measuring all required operating conditions, and make corresponding adjustments to the relevant systems based on that information. These operations must occur quickly, and should be open to control from the operator. Additionally, the system should be able to respond very rapidly to conditions that require a process shutdown, such as overheats, material depletion, emergency shut-downs, or any other condition that may pose a threat to the machine, the pultrusion, or the operator.

The current controls system concept has three distinct physical layers:
1. Main controller: the master device on the network, likely a Raspberry Pi or similar microcomputer solution.
2. Sub-controller network: a network of slave controller devices, connected to the main controller via a standard communication protocol (likely a UART, I2C or similar serial bus. These devices are likely to be Arduino microcontrollers.
3. Sensors and outputs: all sensors and digital outputs from the system will be connected to a sub-controller.

A full spreadsheet detailing the locations, functions, and types of sensors expected to be used is available on the network in the controls folder of the most current system design. A rough summary of the sensors and network layout is detailed below.

xxx. Sensors by Zone

There are a total of seven distinct sections of the machine as it currently stand. The relevant sensors for each section are as follows.

### 1. Creel

a. Material runout detection, handled by optical break-beam sensors.
a. Material exit temperature, measured by an infrared temperature sensor directed towards the tape bundle at the end of the preheater section.
b. Runoff material temperature. To prevent the sheared off excess material from accumulating inside the machine, the exit surfaces must be heated. A thermocouple will measure the temperature of the runoff surfaces.

### 3. Heated Die/Consolidator

a. Section temperature. Thermocouples will measure the temperature of the three die sections, likely at the inlet and outlet of each section.
b. Consolidator temperature, measured by a thermocouple.

### 4. Cooled Die

a. Die temperature, measured by thermocouples likely at the die inlet and outlet.
b. Coolant temperature, measured by a thermocouple.

### 5. Post Cooler

a. Coolant temperature, measured by a thermocouple.

### 6. Puller

a. Track speed, measured by an encoder of some for. This will measure the speed of each puller track to provide feedback for the closed-loop speed control.
a. Material speed, measured by an encoder wheel contacting the material. This will check that the material is being pultruded at the same speed as the tracks, and will alert the system in the event that the material beings slipping in the puller.
b. Vertical positon of the tracks, determined by a slide potentiometer fixed between the tracks.

### 7. Cutoff Section

a. Cutoff completion status, determined by a contact switch triggered by the saw arm after cutting through the composite.
b. Cut return status, determined by a second contact switch triggered when the saw arm returns to its vertical position.
c. Carriage return status, determined by a third contact switch triggered when the saw carriage returns to its original position to start the next cut.
   xxxi. Possible Additional Considerations

Owing to the lack of data regarding the operating parameters of thermoplastic pultrusion, it may be advantageous to take as much data regarding the system and process as possible to aid in future designs and processes. To this end, there are a number of sensors that may be deployed to the system to record more useful data.
1. Die pressure. This may be measured in a number of way. The most promising method may take advantage of the split dies being use. A short die section would be introduced into the process at some point in the heated die. This section would be on the order of 2-4″, and would be held closed by two bolt. These bolts would be fitted with bolt load cells to measure the compressive load. During operation, the load cells would then measure the reduction in compressive load that correlates to the pressure within the die.
2. Pultrusion force. Knowing the pultrusion speed, die pressure, and pultrusion force would allow for a much more general characterization of the pultrusion process. This could be measured by introducing a load cell at the load bearing connection between the puller and the die frame.

### REFERENCES

www.sd3d.com/wp-content/uploads/2017/06/MaterialTDS-PETG_01.pdf-Thermal conductivity of PETg and Heat Capacity of PETg
www.matweb.com/search/datasheet_print.aspx?matguid=4de1c85bb946406a 86c52b688e3810d0-Density of PETg
www.matweb.com/search/DataSheet.aspx?MatGUID-d9c18047c49147a2a7c 0b0bb1743e812-Density of E-glass
www.sd3d.com/wp-content/uploads/2017/06/MaterialTDS-PETG_01.pdf-Heat Capacity of PETg
www.azom.com/properties.aspx?ArticleID=764-Thermal Conductivity of E-glass and PETg
J. Sucec, Heat Transfer. Mumbai: Jaico Publishing House, 2005.

### EQUIVALENTS

Those skilled in the art will recognize, or be able to ascertain using no more than routine experimentation, many equivalents to the specific embodiments of the invention described herein. The scope of the present invention is not intended to be limited to the above Description, but rather is as set forth in the following claims:

What is claimed is:

1. A method for manufacturing thermoplastic products (e.g., continuous fiber thermoplastic composite parts) from a feed material, the method comprising:
i) providing the feed material;
ii) heating the feed material to a first temperature to produce a heated feed material, wherein the first temperature is above the glass transition temperature of at least one component of the feed material;
iii) forming a consolidated material from the heated feed material; and
iv) cooling the consolidated material to a second temperature.

2. The method of claim 1, wherein providing the feed material comprises:
i) pulling each of the feed material, heated feed material, and consolidated material through each of steps i), ii), iii), and iv); and/or
ii) controlling a tension force on the feed material (e.g., by applying a tension force to the feed material by a tensioning unit).

3. The method of any one of the preceding claims wherein, the feed material is a continuous fiber thermoplastic composite material comprising:
i) a fiber component;
ii) a thermoplastic component;
iii) a functional component; or
iv) any combination thereof,
wherein the fiber component and the thermoplastic component are commingled.

4. The method of claim 3, wherein the fiber component comprises a fiber selected from the group consisting of: i) glass fiber (e.g., E-glass); ii) carbon fiber; iii) aramid fiber; iv) basalt fiber; v) organic fiber (e.g., hemp fiber, e.g., wood-derived fiber; and vi) any combination thereof.

5. The method of claim 3 or 4, wherein the thermoplastic component comprises a thermoplastic polymer selected from the group consisting of: polyethylene terephthalate (PET), polyethylene terephthalate glycol (PETg), polycarbonate, polyethylene (e.g., high-density polyethylene (HDPE), e.g., low-density polyethylene (LDPE)), polypropylene, polyetheretherketone, polyaryletherketone (e.g., low melt polyaryletherketone), polyamide (e.g., nylon 6, nylon 6 6, nylon 6 12, nylon 4,6 nylon 12, etc.), acrylonitrile butadiene styrene, polylactic acid, polyvinylchloride, or any combination thereof.

6. The method of any one of the preceding claims further comprising: finishing the thermoplastic product, wherein finishing comprises: i) surfacing; (e.g., deforming a surface of the thermoplastic product); ii) filament winding; iii) tape winding; iv) bending; v) curving; vi) cutting; or vii) any combination thereof.

7. The method of any one of the preceding claims, wherein the method does not comprise saturating the fiber component with the thermoplastic component.

8. The method of any one of the preceding claims, wherein the thermoplastic product is selected from the group consisting of: reinforcing bar (e.g., rebar), a plate (e.g., a flat plate), an I-beam, a Pi preform, a structural angle, a structural channel (e.g., a C-channel), a hollow structural section, and a pipe.

9. The method of any one of the preceding claims, wherein heating the feed material comprises subjecting the feed material to at least one heating source.

10. The method of claim 9, wherein the heating source is selected from the group consisting of: a) a radiative heater; b) a convective heater; c) an inductive hater; and d) a resistance heater; or e) any combination thereof.

11. The method of any one of the preceding claims, wherein forming the consolidated material from the heated feed material comprises:
i) collecting at least a portion of the heated feed material at the first temperature;
ii) optionally heating the heated feed material to a third temperature;
iii) optionally cooling the heated feed material to a fourth temperature; and
iv) applying pressure (e.g., applying a consolidation pressure) to the heated feed material.

12. The method of claim 11, wherein applying pressure to the heated feed material is performed substantially simultaneously with at least one of i), ii), and/or iii).

13. The method of claim 11 or 12, wherein the third temperature is intermediate of the first temperature and the second temperature.

14. The method of any one of claims 11-13, wherein, after forming the consolidated material from the heated feed material, the consolidated material has a cross-section (e.g., a cross-section dimension, e.g., a cross-section shape) different than a cross-section of the heated feed material.

15. The method of any one of the preceding claims, wherein cooling the consolidated material comprises:
i) initially cooling the consolidated material to (a) below the glass transition temperature of the feed material or (b) below the melt transition temperature of the feed material; and/or
ii) subsequently cooling the consolidated material to ambient temperature (e.g., room temperature).

16. A continuous forming machine for manufacturing a thermoplastic product from a feed material, the machine comprising: i) a loading unit; ii) a tensioning unit; iii) a heating unit; iv) a forming unit; v) a cooling unit; and vi) a pulling unit, wherein the continuous forming machine is capable of using feed materials comprising thermoplastic materials.

17. The continuous forming machine of claim 16, wherein the machine does not comprise: (i) a saturating unit; and/or (ii) a vacuum unit.

18. The continuous forming machine of claim 17, wherein the saturating unit is selected from the group consisting of: a resin bath saturating unit, a resin injection saturating unit, and a combination of both.

19. The continuous forming machine of any one of claims 16-18, wherein the feed material is a continuous fiber thermoplastic composite material comprising: i) a fiber component; ii) a thermoplastic component; iii) a functional component; or iv) any combination thereof, wherein the fiber component and the thermoplastic component are commingled.

20. The continuous forming machine of claim 19, wherein the fiber component comprises a fiber selected from the group consisting of: i) glass fiber (e.g., E-glass); ii) carbon fiber; iii) aramid fiber; iv) basalt fiber; v) organic fiber (e.g., hemp fiber, e.g., wood-derived fiber; and vi) any combination thereof.

21. The continuous forming machine of claim 19 or 20, wherein the thermoplastic component comprises a thermoplastic polymer selected from the group consisting of: polyethylene terephthalate (PET), polyethylene terephthalate glycol (PETg), polycarbonate, polyethylene (e.g., high-density polyethylene (HDPE), e.g., low-density polyethylene (LDPE)), polypropylene, polyetheretherketone, polyaryletherketone (e.g., low melt polyaryletherketone), polyamide (e.g., nylon 6, nylon 6 6, nylon 6 12, nylon 4,6 nylon 12, etc.), acrylonitrile butadiene styrene, polylactic acid, polyvinylchloride, or any combination thereof.

22. The continuous forming machine of any one of claims 16-21, wherein the loading unit stores at least 1, at least 5, at least 10, at least 15, at least 20, at least 25, at least 30, at least 35, at least 40, at least 45, at least 50 storage modules (e.g., spools, e.g., bobbins, e.g., reels, e.g., coils) of the feed material.

23. The continuous forming machine of any one of claims 16-22, wherein the heating unit comprises at least one heating source.

24. The continuous forming machine of claim 23, wherein the at least one heating source is selected from the group consisting of: a radiative heater, a convective heaters, an inductive heater, a resistance heater, or any combination thereof.

25. The continuous forming machine of any one of claims 16-24, wherein the forming unit comprises a collecting unit and at least one consolidating die.

26. The continuous forming machine of any one of claims 16-25, wherein the pulling unit is selected from the group consisting of: a reciprocating pulling unit and a traction pulling unit.

27. The continuous forming machine of claim 26, wherein the pulling unit pulls the feed material at a rate within a range of about 0.1 ft/min to about 200 ft/min, at a rate within a range of about 0.1 ft/min to about 15 ft/min, or at a rate within a range of about 1 ft/min to about 10 ft/min.

28. The continuous forming machine of any one of claims 16-27, wherein the machine further comprises: i) a thermoplastic injecting unit, ii) a roll forming unit, iii) a surface reforming unit, iv) a tape/filament winding unit, v) a bending/curving unit, vi) a conveying unit, vii) a cutting unit, and viii) any combination thereof.

29. The continuous forming machine of any one of claims 16-28, wherein the thermoplastic product is selected from the group consisting of: reinforcing bar (e.g., rebar), a plate (e.g., a flat plate), an I-beam, a Pi preform, a structural angle, a structural channel (e.g., a C-channel), a hollow structural section, and a pipe.
